(19) United States
(12) Patent Application Publication
(10) Pub. No.: US 2025/0101270 A1
(43) Pub. Date: Mar. 27, 2025

(54) PRESSURE-SENSITIVE ADHESIVE

(71) Applicant: LG CHEM, LTD., Seoul (KR)

(72) Inventors: Byeong Ho KIM, Daejeon (KR); Byung Su PARK, Daejeon (KR); Hui Je LEE, Daejeon (KR); Jin Seo MIN, Daejeon (KR)

(73) Assignee: LG CHEM, LTD., Seoul (KR)

(21) Appl. No.: 18/714,889

(22) PCT Filed: Jan. 5, 2023
(86) PCT No.: PCT/KR2023/000243

§ 371 Date: May 30, 2024

(30) Foreign Application Priority Data
Jan. 6, 2022 (KR) 10-2022-0002056

(51) Int. Cl. C09J 7/38; C09J 133/06; C09J 133/08

(52) U.S. Cl. CPC C09J 7/385; C09J 133/06; C09J 133/066; C09J 133/08; C09J 2301/312

(57) ABSTRACT

The present application can provide a pressure-sensitive adhesive suitable for a flexible device, and a device comprising the same. In one example, the present application can provide a pressure-sensitive adhesive that is applied to a flexible device to effectively respond to repeated deformation and recovery, does not cause defects before and after deformation, and has excellent recoverability as well.

This application is a 35 U.S.C. § 371 National Phase Entry Application from PCT/KR2023/000243, filed on Jan. 5, 2023, which claims the benefit of priority based on Korean Patent Application No. 10-2022-0002056 dated Jan. 6, 2022, the disclosures of which are incorporated herein by reference in their entireties.

### TECHNICAL FIELD

The present application relates to a pressure-sensitive adhesive and a use thereof.

### BACKGROUND

As a type of flexible device, a so-called foldable or rollable device, and the like is known. Such a device is repeated a plurality of times in a process of being folded and then unfolded again or a process of being wound and then unwound again.

Therefore, the pressure-sensitive adhesive applied to the foldable device must be able to effectively respond to the stress applied in the process of repeated deformation. Conventionally, in order to obtain such a pressure-sensitive adhesive, attention has been mainly paid to the elastic modulus, particularly the elastic modulus at low temperature, of the pressure-sensitive adhesive. In general, it is known that the lower the elastic modulus at low temperature, the more effectively it can respond to the stress applied by the repetitive deformation.

However, when the pressure-sensitive adhesive is designed by focusing only on the low elastic modulus, there is a tendency that recoverability, reliability, and cuttability, and the like are lowered.

As described above, the foldable or rollable devices are repeated a plurality of times in the process of being folded and then unfolded again or the process of being wound and then unwound again, so that the property of returning to the original state after deformation is also required, but in the pressure-sensitive adhesive, which has simply only a low elastic modulus, the recovering properties are lowered.

In addition, in a process of manufacturing a device, the pressure-sensitive adhesive is cut into a desired shape, but the pressure-sensitive adhesive with an excessively low elastic modulus has poor cuttability, and the low elastic modulus is also disadvantageous in terms of reliability of the pressure-sensitive adhesive.

### DISCLOSURE

### Technical Problem

The present application relates to a pressure-sensitive adhesive. The present application is intended to provide a pressure-sensitive adhesive having excellent recoverability, cuttability and reliability while having followability and stress characteristics capable of effectively responding to repeated deformation. The present application is also intended to provide a use of the pressure-sensitive adhesive. In one example, the pressure-sensitive adhesive may be effectively applied to constructing a flexible device such as a foldable device or a rollable device.

### Technical Solution

Among the physical properties mentioned in this specification, when the measured temperature affects the relevant physical property, the physical property is a physical property measured at room temperature, unless otherwise specified.

In this specification, the term room temperature is a temperature in a state where it is not particularly warmed and cooled, which may mean any one temperature within the range of about 10° C. to 30° C., for example, a temperature of about 27° C. or less while being about 15° C. or more, 18° C. or more, 20° C. or more, or about 23° C. or more. In addition, unless otherwise specified, the unit of temperature mentioned in this specification is ° C.

Among the physical properties mentioned in this specification, when the measured pressure affects the relevant physical property, the physical property is a physical property measured at normal pressure, unless otherwise specified.

In this specification, the term normal pressure is a pressure in a state where it is not particularly pressurized and depressurized, which usually means a pressure of about 700 mmHg to 800 mmHg or so, which is the atmospheric pressure level.

Among the physical properties mentioned in this specification, when the measured humidity affects the relevant physical property, the physical property is a physical property measured at natural humidity in the state of the room temperature and normal pressure, unless otherwise specified.

The present application relates to a pressure-sensitive adhesive.

The pressure-sensitive adhesive of the present application exhibits characteristics to be described below, where such characteristics are useful in devices in which repeated deformation and recovery occur, for example, flexible devices such as foldable devices or rollable devices.

In one example, the pressure-sensitive adhesive may exhibit a low stress under an environment in which deformation is applied instantaneously, and then such deformation is maintained for a certain time, and may also exhibit characteristics of relieving the applied stress in a relatively short time.

For example, the pressure-sensitive adhesive may have a maximum stress (S_{MAX}) as identified while applying a shear force so that a strain of 100% is applied within 0.05 seconds at −20° C., and then maintaining the strain of 100% for 1200 seconds in a predetermined range.

A method of measuring the maximum stress S_{MAX} is described in an example of this specification (Stress-Relaxation measurement item in Examples). The S_{MAX}, and S₁₂₀₀ to be described below may be measured using a measuring instrument such as, for example, ARES G2 (Advanced Rheometric Expansion System G2) (TA), wherein the pressure-sensitive adhesive is applied as a circular shape with a thickness of about 800 μm or so and a diameter of about 8 mm or so. In one example, the upper limit of the maximum stress S_{MAX} may be 1 MPa, 0.9 MPa, 0.8 MPa, 0.7 MPa, 0.6 MPa, 0.5 MPa, or 0.4 MPa or so. The lower limit of the maximum stress S_{MAX} is not particularly limited. For example, the lower limit of the stress S_{MAX} may also be about 0.01 MPa, 0.05 MPa, 0.1 MPa, 0.15 MPa, 0.2 MPa, 0.25 MPa, 0.3 MPa, or 0.35 MPa or so. The maximum stress S_{MAX} may be less than or equal to, or less than any one of the above-described upper limits, or may be more than or equal to, or more than any one of the above-described lower limits while being less than or equal to, or less than any one of the above-described upper limits.

In the process of maintaining the strain of 100% for 1200 seconds, the pressure-sensitive adhesive may have a stress (S₁₂₀₀) at a time point when the strain of 100% is maintained for 1200 seconds in a predetermined range. The stress may also be evaluated according to the evaluation method in the stress-relaxation measurement item of the example of this specification.

The upper limit of the stress S₁₂₀₀ may be 12,000 Pa, 11,000 Pa, 10,000 Pa, 9,500 Pa, 9,000 Pa, 8,500 Pa, 8,000 Pa, or 7,500 Pa or so, and the lower limit thereof may also be 1,000 Pa, 2,000 Pa, 3,000 Pa, 4,000 Pa, 5,000 Pa, 6,000 Pa, 7,000 Pa, or 8,000 Pa or so. The maximum stress S₁₂₀₀ may be less than or equal to, or less than any one of the above-described upper limits, or may be more than or equal to, or more than any one of the above-described lower limits while being less than or equal to, or less than any one of the above-described upper limits.

The pressure-sensitive adhesive exhibiting such characteristics can effectively respond to stress applied to the pressure-sensitive adhesive in an environment where the instantaneously applied deformation is maintained for a certain time, and such a pressure-sensitive adhesive can also exhibit excellent cuttability, workability, recoverability, and reliability.

The pressure-sensitive adhesive may also have a ratio S_{MAX}/S₁₂₀₀ of the maximum stress S_{MAX} and the stress S₁₂₀₀ in a predetermined range. For example, the lower limit of the ratio S_{MAX}/S₁₂₀₀ may be 30, 32, 34, 36, 38, 40, 42, 44, 46, or 48 or so, and the upper limit thereof may be 60, 58, 56, 54, 52, 50, 48, 46, or 44 or so. The ratio S_{MAX}/S₁₂₀₀ may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits.

The pressure-sensitive adhesive can effectively respond to the stress applied to the pressure-sensitive adhesive in an environment where the instantaneously applied deformation is repeated, and such a pressure-sensitive adhesive can also exhibit excellent cuttability, workability, recoverability, and reliability.

The pressure-sensitive adhesive may have ΔS_{X1} of Equation 1 below in a predetermined range.

$$Δ {S}_{X 1} = 0.02 \times ( {S}_{MAX 1} - {S}_{MAX 50} ) \qquad [ Equation l ]$$

In Equation 1, S_{MAX1} and S_{MAX50} are maximum stresses identified at specific time points in the process of applying a shear force to the pressure-sensitive adhesive according to the Sin wave equation.

That is, in Equation 1, S_{MAX1} is the maximum stress (unit: Pa) identified within a time period of 0 seconds to 2 seconds in the process of applying a shear force to the pressure-sensitive adhesive for 100 seconds according to Equation 2 below, and S_{MAX50} is the maximum stress (unit: Pa) identified within a time period of 99 seconds to 100 seconds in the process of applying a shear force to the pressure-sensitive adhesive for 100 seconds according to Equation 2 below.

$$Sin wave equation = 4 \times sin ( 1.575 \times t ) \qquad [ Equation 2 ]$$

In Equation 2, t is a time (unit: sec).

Unless specifically specified otherwise, the unit of maximum stress or stress in this specification is Pa.

The process and measurement method of applying the shear force according to Equation 2 above are described in the Example section (stress measurement section for sin strain) of this specification. The shear force application is performed at −20° C.

The application of the shear force may be performed using a measuring device such as, for example, ARES G2 (Advanced Rheometric Expansion System G2) (TA). At this time, the pressure-sensitive adhesive is applied as a circular shape having a thickness of about 800 μm or so and a diameter of about 8 mm or so.

When a shear force is applied to the pressure-sensitive adhesive according to Equation 2, a process, in which a certain level of strain is applied to the pressure-sensitive adhesive for a certain time and then a certain level of strain is applied in the reverse direction, is repeated. For example, when a shear force is applied according to Equation 2, the process, in which the shear force is applied for 1 second so that a strain of 400% or so is applied to the pressure-sensitive adhesive in a time of 1 second, and then the shear force is subsequently applied for 1 second in the reverse direction so that a strain of 0% is applied to the pressure-sensitive adhesive in a time of 1 second, may be repeated, where the application of the shear force for 2 seconds is defined as 1 cycle. Here, the reverse direction means that the shear force is applied in the direction opposite to the direction of the shear force applied so that the strain of 400% is applied in a time of 1 second.

Therefore, S_{MAX1} in Equation 1 above is the maximum stress identified while the above 1 cycle is performed once, and S_{MAX50} is the maximum stress identified when the application of the shear force according to the shear force application cycle has been repeated 50 times, that is, within the 50th cycle.

When the shear force is applied in such a manner, the strain (Sin Strain) with a shape similar to the Sin curve may be applied to the pressure-sensitive adhesive, and ΔS_{X1} of Equation 1 may be within a predetermined range under the strain applied in such a manner.

For example, the upper limit of ΔS_{X1} in Equation 1 may be 3500 Pa/time, 3400 Pa/time, 3300 Pa/time, 3200 Pa/time, 3100 Pa/time, 3000 Pa/time, 2900 Pa/time, 2800 Pa/time, 2700 Pa/time, 2600 Pa/time, 2500 Pa/time, 2400 Pa/time, or 2300 Pa/time or so, and the lower limit thereof may be 1000 Pa/time, 1200 Pa/time, 1400 Pa/time, 1600 Pa/time, 1800 Pa/time, 2000 Pa/time, or 2200 Pa/time or so. The ΔS_{X1} may be less than or equal to, or less than any one of the above-described upper limits, or may be more than or equal to, or more than any one of the above-described lower limits while being less than or equal to, or less than any one of the above-described upper limits.

The upper limit of S_{MAX50} in Equation 1 may be 250,000 Pa, 245,000 Pa, 240,000 Pa, 235,000 Pa, 230,000 Pa, 225,000 Pa, 220,000 Pa, 215,000 Pa, 210,000 Pa, 205,000 Pa, 200,000 Pa, 195,000 Pa, 190,000 Pa, or 185,000 Pa or so, and the lower limit thereof may be 100,000 Pa, 110,000 Pa, 120,000 Pa, 130,000 Pa, 140,000 Pa, 150,000 Pa, 160,000 Pa, 170,000 Pa, or 180,000 Pa or so. The S_{MAX50} may be less than or equal to, or less than any one of the above-described upper limits, or may be more than or equal to, or more than any one of the above-described lower limits while being less than or equal to, or less than any one of the above-described upper limits.

The pressure-sensitive adhesive can effectively respond to the stress applied to the pressure-sensitive adhesive in an environment where the instantaneously applied deformation is repeated, and such a pressure-sensitive adhesive can also exhibit excellent cuttability, workability, recoverability, and reliability.

The pressure-sensitive adhesive may also have ΔS_{X2} of Equation 3 below in a predetermined range. The pressure-sensitive adhesive satisfying the above condition can more effectively satisfy physical properties required for flexible devices.

$$Δ {S}_{X 2} = 0.1 \times ( {S}_{MAX 1} - {S}_{MAX 10} ) \qquad [ Equation 3 ]$$

S_{MAX1} in Equation 3 is the same as S_{MAX1} in Equation 1.

S_{MAX10} in Equation 3 is the maximum stress (unit: Pa) identified within a time of 19 seconds to 20 seconds in the process of applying a shear force to the pressure-sensitive adhesive for 100 seconds according to Equation 2 in the same manner as the method of identifying S_{MAX1} and S_{MAX50} in Equation 1.

This S_{MAX10} is the maximum stress identified within the 10th cycle when the shear force application according to the shear force application cycle described in Equation 1 has been repeated 10 times.

The upper limit of ΔS_{X2} in Equation 3 may be 15,000 Pa/time, 14,000 Pa/time, 13,000 Pa/time, 12,000 Pa/time, 11,000 Pa/time, 10,000 Pa/time, or 9,500 Pa/time or so, and the lower limit thereof may be 5,000 Pa/time, 6,000 Pa/time, 7,000 Pa/time, 8,000 Pa/time, 8,500 Pa/time, or 9,000 Pa/time or so. The ΔS_{X2} may be less than or equal to, or less than any one of the above-described upper limits, or may be more than or equal to, or more than any one of the above-described lower limits while being less than or equal to, or less than any one of the above-described upper limits.

The upper limit of S_{MAX10} in Equation 3 may be 300,000 Pa, 280,000 Pa, 260,000 Pa, 240,000 Pa, 220,000 Pa, or 210,000 Pa or so, and the lower limit thereof may be 90,000 Pa, 100,000 Pa, 150,000 Pa, or 200,000 Pa or so. The S_{MAX10} may be less than or equal to, or less than any one of the above-described upper limits, or may be more than or equal to, or more than any one of the above-described lower limits while being less than or equal to, or less than any one of the above-described upper limits.

The pressure-sensitive adhesive may also have ΔS_{X3} of Equation 4 below in a predetermined range. The pressure-sensitive adhesive satisfying the above condition can more effectively satisfy physical properties required for flexible devices.

$$Δ {S}_{X 3} = 0.025 \times ( {S}_{MAX 10} - {S}_{MAX 50} ) \qquad [ Equation 4 ]$$

S_{MAX10} in Equation 4 is the same as S_{MAX10} in Equation 3, and S_{MAX50} is the same as S_{MAX50} in Equation 1.

The upper limit of ΔS_{X3} may be 700 Pa/time, 650 Pa/time, or 600 Pa/time or so, and the lower limit thereof may be 100 Pa/time, 200 Pa/time, 300 Pa/time, 400 Pa/time, or 550 Pa/time or so. The ΔS_{X3} may be less than or equal to, or less than any one of the above-described upper limits, or may be more than or equal to, or more than any one of the above-described lower limits while being less than or equal to, or less than any one of the above-described upper limits.

The upper limit of S_{MAX1} in Equation 1 may be 350,000 Pa, 340,000 Pa, 330,000 Pa, 320,000 Pa, 310,000 Pa, or 300,000 Pa or so, and the lower limit thereof may be 100,000 Pa, 150,000 Pa, 200,000 Pa, or 250,000 Pa or so. The S_{MAX1} may be less than or equal to, or less than any one of the above-described upper limits, or may be more than or equal to, or more than any one of the above-described lower limits while being less than or equal to, or less than any one of the above-described upper limits.

The pressure-sensitive adhesive may also have ΔS_{XL1} of Equation 5 below in a predetermined range. The pressure-sensitive adhesive satisfying the above condition can more effectively satisfy physical properties required for flexible devices.

$$Δ {S}_{XL 1} = ( {S}_{MAX 1} - {S}_{LAST 1} ) \qquad [ Equation 5 ]$$

S_{MAX1} in Equation 5 is the same as S_{MAX1} in Equation 1.

In Equation 5, S_{LAST1} is the stress identified immediately after applying the shear force to the pressure-sensitive adhesive once according to the shear force application cycle.

That is, S_{LAST1} in Equation 5 is the stress (unit: Pa) identified at 2 seconds in the process of applying a shear force to the pressure-sensitive adhesive for 100 seconds according to Equation 2 in the same manner as the method of identifying S_{MAX1} and S_{MAX50} in Equation 1, that is, the stress (unit: Pa) identified immediately after 2 seconds have elapsed in the application process for 100 seconds.

The upper limit of ΔS_{XL1} in Equation 5 may be 600,000 Pa, 550,000 Pa, 500,000 Pa, or 450,000 Pa or so, and the lower limit thereof may be 100,000 Pa, 150,000 Pa, 200,000 Pa, 250,000 Pa, 300,000 Pa, 350,000 Pa, or 400,000 Pa or so. The ΔS_{XL1} may be less than or equal to, or less than any one of the above-described upper limits, or may be more than or equal to, or more than any one of the above-described lower limits while being less than or equal to, or less than any one of the above-described upper limits.

The pressure-sensitive adhesive may have ΔS_{XL50} of Equation 6 below in a predetermined range. The pressure-sensitive adhesive satisfying the above condition can more effectively satisfy physical properties required for flexible devices.

$$Δ {S}_{XL 50} = ( {S}_{MAX 50} - {S}_{L AST 50} ) \qquad [ Equation 6 ]$$

S_{MAX50} in Equation 6 is the same as S_{MAX50} in Equation 1.

In Equation 6, S_{LAST50} is the stress identified immediately after applying the shear force to the pressure-sensitive adhesive 50 times according to the shear force application cycle.

That is, S_{LAST50} in Equation 6 is the stress (unit: Pa) identified at 100 seconds in the process of applying a shear force to the pressure-sensitive adhesive for 100 seconds according to Equation 2 in the same manner as the method of identifying S_{MAX1} and S_{MAX50} in Equation 1, that is, the stress (unit: Pa) identified immediately after 100 seconds have elapsed in the application process for 100 seconds.

The upper limit of ΔS_{XL50} in Equation 6 may be 500,000 Pa, 480,000 Pa, 460,000 Pa, 440,000 Pa, 420,000 Pa, 400,000 Pa, 380,000 Pa, or 360,000 Pa or so, and the lower limit thereof may be 100,000 Pa, 150,000 Pa, 200,000 Pa, 250,000 Pa, 300,000 Pa, or 350,000 Pa or so. The ΔS_{XL50} may be less than or equal to, or less than any one of the above-described upper limits, or may be more than or equal to, or more than any one of the above-described lower limits while being less than or equal to, or less than any one of the above-described upper limits.

The pressure-sensitive adhesive may have ΔS_{XL10} of Equation 7 below in a predetermined range. The pressure-sensitive adhesive satisfying the above condition can more effectively satisfy physical properties required for flexible devices.

$$Δ {S}_{XL 10} = ( {S}_{MAX 10} - {S}_{LAST 10} ) \qquad [ Equation 7 ]$$

S_{MAX10} in Equation 7 is the same as S_{MAX10} in Equation 3.

In Equation 7, S_{LAST10} is the stress identified immediately after applying the shear force to the pressure-sensitive adhesive 10 times according to the shear force application cycle.

That is, S_{LAST10} in Equation 7 is the stress (unit: Pa) identified at 20 seconds in the process of applying a shear force to the pressure-sensitive adhesive for 100 seconds according to Equation 2 in the same manner as the method of identifying S_{MAX1} and S_{MAX50} in Equation 1, that is, the stress (unit: Pa) identified immediately after 20 seconds have elapsed in the application process for 100 seconds.

The upper limit of ΔS_{XL10} in Equation 7 may be 500,000 Pa, 480,000 Pa, 460,000 Pa, 440,000 Pa, 420,000 Pa, 400,000 Pa, or 380,000 Pa or so, and the lower limit thereof may be 100,000 Pa, 150,000 Pa, 200,000 Pa, 250,000 Pa, 300,000 Pa, or 350,000 Pa or so. The ΔS_{XL10} may be less than or equal to, or less than any one of the above-described upper limits, or may be more than or equal to, or more than any one of the above-described lower limits while being less than or equal to, or less than any one of the above-described upper limits.

The pressure-sensitive adhesive may satisfy at least one of the above-described characteristics; in one example, it may satisfy a combination of two or more of the above-described characteristics; and it may suitably satisfy all of the above-described characteristics.

In general, the confirmation of whether a pressure-sensitive adhesive is suitable for a flexible device such as a foldable device has been performed by identifying the elastic modulus of the pressure-sensitive adhesive. For example, generally, it has been known that it is advantageous for a pressure-sensitive adhesive applied to a flexible device to have a low elastic modulus at a low temperature because it is exposed to repeated deformation, and it is common that the matter of whether the pressure-sensitive adhesive is suitable for a flexible device is confirmed by whether the relevant pressure-sensitive adhesive has a low elastic modulus, particularly, a low elastic modulus at a low temperature.

However, in the case of focusing only on the low-temperature elastic modulus of the pressure-sensitive adhesive, when the pressure-sensitive adhesive is actually applied to a flexible device, problems that in an environment where deformation applied instantaneously to the device is repeated, it does not effectively follow the deformation, or even if it follows, recovery is insufficient when the deformation disappears often occur, and in some cases, it often happens that the performance of the device is adversely affected by the stress applied to the pressure-sensitive adhesive under the repeated deformation.

However, when the pressure-sensitive adhesive is designed to exhibit at least one of the above characteristics, in a state where it is actually applied to a flexible device, the pressure-sensitive adhesive may be made to exhibit performance suitable for the device.

The pressure-sensitive adhesive may also maintain or improve the performance of other components, or prevent deterioration of the performance, in a state where it is applied to the device.

For example, the pressure-sensitive adhesive may exhibit characteristics that the absolute value of ΔR1 in Equation 8 below is in a predetermined range.

$$Δ {R}_{1} = 100 \times ( R 5 - Ri ) / R i \qquad [ Equation 8 ]$$

In Equation 8, R5 is, in a process of folding and unfolding a laminate comprising an ITO (indium tin oxide) film, the pressure-sensitive adhesive, and a PET (poly(ethylene terephthalate)) film in this order once for 2 seconds, the resistance of the ITO layer in the ITO film after repeating the process 50,000 times, and Ri is the resistance of the ITO layer in the ITO film before repeating the process of folding and unfolding 50,000 times.

Even if the pressure-sensitive adhesive is applied to a device comprising electrodes to be exposed to repeated deformation, it may be made so that the characteristics of the electrodes are stably maintained.

The upper limit of the absolute value of ΔR1 in Equation 8 may be 200%, 195%, 190%, 185%, 180%, 175%, 170%, 165%, 160%, 155%, 150%, 145%, 140%, 135%, 130%, 125%, 120%, 115%, 110%, 105%, or 100% or so, and the lower limit thereof may be 0%, 10%, 20%, 30%, 40%, 50%, 60%, 70%, 80%, 90%, 110%, 120%, 130%, 140%, or 150% or so. The absolute value of ΔR1 may be less than or equal to, or less than any one of the above-described upper limits, or may be more than or equal to, or more than any one of the above-described lower limits while being less than or equal to, or less than any one of the above-described upper limits.

A method of constructing the laminate checking the ΔR1 will be described with reference to FIG. 1. As shown in FIG. 1, the laminate may be manufactured to have a laminated structure of ITO film/pressure-sensitive adhesive layer/PET film by laminating an ITO (indium tin oxide) film and a PET (poly(ethylene terephthalate)) film via the pressure-sensitive adhesive. Such a laminate may be applied to the folding by cutting it to have a width of about 15 cm and a length of about 2.5 cm.

As the ITO film, one having a crystalline ITO (Indium Tin Oxide) layer with a thickness of about 1 μm or so formed on the surface of a PET (poly(ethylene terephthalate)) film (base film) with a thickness of about 50 μm or so may be used, and as the PET film, a film with a thickness of about 50 μm or so may be used. The thickness of the pressure-sensitive adhesive layer applied to the laminate may be adjusted to about 25 μm or so, and during lamination, the base film of the ITO film is laminated so as to be in contact with the pressure-sensitive adhesive.

As shown in FIG. 1, a silver paste is printed with a width of about 1 cm on the ITO layer of the cut laminate. Two silver pastes are printed in a state of being about 4 cm or so apart from the left and right based on the center of the ITO layer (dotted line in the lower drawing of FIG. 1), and after printing, the printed pastes are dried at about 150° C. for 1 hour or so.

The folding may be performed using the laminate as a specimen. At this instance, in the folding, the laminate is loaded into a dynamic chamber, and a process of folding and unfolding the specimen once at the center portion (dotted line portion in the lower drawing of FIG. 1) is set as one cycle, whereby the cycle is repeated. The folding is performed with a curvature of about 2.5R, and the performance temperature is fixed at −20° C. The process of folding and unfolding once in one cycle is performed for 2 seconds, and the folding proceeds with the silver paste of the ITO film coming to the top.

The initial resistance (Ri) of the ITO layer before folding is obtained using the silver paste, and the resistance (R5) of the ITO layer after folding 50,000 times is obtained, where ΔR1 may be obtained by substituting them into Equation 8.

The pressure-sensitive adhesive can also maintain the characteristics of the ITO layer even after further repeating the folding.

For example, the pressure-sensitive adhesive may exhibit characteristics that ΔR2 in Equation 9 below or an absolute value thereof is in a predetermined range.

$$Δ {R}_{2} = 100 \times ( R 10 - Ri ) / R i \qquad [ Equation 9 ]$$

In Equation 9, R10 is, in a process of folding and unfolding a laminate comprising an ITO (indium tin oxide) film, the pressure-sensitive adhesive, and a PET (poly(ethylene terephthalate)) film in this order once for 2 seconds, the resistance of the ITO layer in the ITO film after repeating the process 100,000 times, and Ri is the resistance of the ITO layer in the ITO film before repeating the process of folding and unfolding 100,000 times.

The folding process for obtaining ΔR2 of Equation 9 is the same as the case of obtaining ΔR1 of Equation 8.

The upper limit of ΔR2 in Equation 9 or its absolute value may be 290%, 285%, 280%, 275%, 270%, 265%, 260%, 255%, 250%, 245%, 240%, 235%, 230%, 225%, 220%, 215%, 210%, 205%, 200%, 195%, 190%, 185%, 180%, 175%, 170%, 165%, 160%, 155%, 150%, 145%, 140%, 135%, 130%, 125%, or 120% or so, and the lower limit may be 0%, 10%, 20%, 30%, 40%, 50%, 60%, 70%, 80%, 90%, 110%, 120%, 130%, 140% or 150%, 155%, 160%, 165%, 170%, 175%, 180%, 185%, 190%, 195%, or 200% or so. The ΔR2 or its absolute value may be less than or equal to, or less than any one of the above-described upper limits, or may be more than or equal to, or more than any one of the above-described lower limits while being less than or equal to, or less than any one of the above-described upper limits.

The pressure-sensitive adhesive may exhibit an excellent recovery rate along with the above-described characteristics. For example, the lower limit of the recovery rate of the pressure-sensitive adhesive may be 70%, 71%, 72%, 73%, 74%, 75%, 76%, 77%, 78%, 79%, 80%, 81%, 82%, or 83% or so, and the upper limit thereof may be 100%, 98%, 96%, 94%, 92%, 90%, 88%, 86%, 84%, or 82% or so. The recovery rate may be more than or equal to, or more than any one of the above-described lower limits, or may be more than or equal to, or more than any one of the above-described lower limits while being less than or equal to, or less than any one of the above-described upper limits.

The recovery rate is a result measured according to the recovery rate measurement method of the example of this specification.

The pressure-sensitive adhesive may exhibit an appropriate elastic modulus at a low temperature.

For example, the upper limit of the elastic modulus at −20° C. of the pressure-sensitive adhesive may be 1 MPa, 0.9 MPa, 0.8 MPa, 0.7 MPa, 0.6 MPa, 0.5 MPa, 0.4 MPa, 0.3 MPa, or 0.2 MPa or so, and the lower limit thereof may be 0.01 MPa, 0.03 MPa, 0.05 MPa, 0.07 MPa, 0.09 MPa, 0.1 MPa, 0.2 MPa, 0.3 MPa, 0.4 MPa, or 0.5 MPa or so. The elastic modulus may be less than or equal to, or less than any one of the above-described upper limits, or may be more than or equal to, or more than any one of the above-described lower limits while being less than or equal to, or less than any one of the above-described upper limits.

In addition, the pressure-sensitive adhesive may have a maximum stress in a linear section of a strain-stress curve for identifying the elastic modulus within a predetermined range. For example, the upper limit of the maximum stress may be 30,000 Pa, 25,000 Pa, 20,000 Pa, 15,000 Pa, 10,000 Pa, or 9,000 Pa or so, and the lower limit thereof may be 1,000 Pa, 3,000 Pa, 5,000 Pa, 7,000 Pa, 8,000 Pa, 8,500 Pa, 10,000 Pa, 15,000 Pa, 20,000 Pa, 22,000 Pa, or 24,000 Pa or so. The maximum stress may be less than or equal to, or less than any one of the above-described upper limits, or may be more than or equal to, or more than any one of the above-described lower limits while being less than or equal to, or less than any one of the above-described upper limits.

The methods of measuring the elastic modulus and maximum stress are described in Examples of this specification (measurement items of elastic modulus and maximum stress).

The elastic modulus is Young's modulus in which the stress applied to the pressure-sensitive adhesive is measured, while a shear force is applied thereto so that a constant strain is generated, to be obtained through a graph showing the change in the stress according to the strain (Strain-Stress curve, a graph showing the X axis as strains (%) and the Y-axis as stresses (Pa)). Such Young's moduli are usually measured in a section where changes in stress versus strain are substantially linear in the strain-stress curve. Since this Young's modulus represents the change rate of stress according to the applied strain, even in the case of pressure-sensitive adhesives having the same Young's modulus, behaviors to the stress may be different, and thus, in order to reflect this, the maximum stress within the linear section may be introduced. That is, the pressure-sensitive adhesive exhibiting the Young's modulus and the maximum stress simultaneously can effectively satisfy the required physical properties of the flexible device.

In one example, in a strain-stress curve shown through a device set so that strains from a strain of 0% to a strain of 400% are constantly generated for 1 second, the linear section may be a section in strains of 0.7% to 4%, and thus, the maximum stress may be a stress at a strain of 4% in the strain-stress curve.

The pressure-sensitive adhesive can exhibit excellent cuttability, workability, recoverability, and reliability along with elastic properties suitable for a foldable device. That is, such a pressure-sensitive adhesive can be applied to a foldable device to exhibit appropriate recoverability, cuttability, and reliability, and the like, while effectively following repeated deformation.

In one example, the pressure-sensitive adhesive exhibiting such characteristics may be the following pressure-sensitive adhesive.

The adhesive may comprise a pressure-sensitive adhesive polymer.

As the pressure-sensitive adhesive polymer, any polymer known in the industry to be capable of forming the pressure-sensitive adhesive may be used. The pressure-sensitive adhesiveness, as is well known, means the property that is agglutinable and peelable by applying pressure at room temperature without using water, solvents, or heat, and the like.

In one example, the pressure-sensitive adhesive polymer may be an acrylic copolymer.

In this specification, the term copolymer means a resulting product of a polymerization reaction of a monomer mixture comprising two or more monomers.

In this specification, the term monomer unit means the state of the monomer after the polymerization reaction.

In this specification, the term acrylic copolymer is a copolymer comprising an acrylic monomer unit as a main component. At this instance, the main component means a case where the ratio of the acrylic monomer unit in the acrylic copolymer is 55 wt % or more, 60 wt % or more, 65 wt % or more, 70 wt % or more, 75 wt % or more, 80 wt % or more, 85 wt % or more, 90 wt % or more, or 95 wt % or more. There is no particular limitation on the upper limit of the content of the acrylic monomer unit in the acrylic copolymer. For example, the acrylic copolymer may comprise the acrylic monomer unit in an amount of 100 wt % or less, or less than 100 wt %.

In this specification, the term acrylic monomer means acrylic acid, methacrylic acid, acrylic acid ester or methacrylic acid ester.

In this specification, the term (meth)acrylic means acrylic or methacrylic.

In the case where the pressure-sensitive adhesive polymer in the pressure-sensitive adhesive of the present application is cross-linkable, the polymer in the pressure-sensitive adhesive may be in a state after cross-linking. Such a pressure-sensitive adhesive may be formed, for example, by cross-linking a pressure-sensitive adhesive composition comprising the pressure-sensitive adhesive polymer.

The pressure-sensitive adhesive may comprise the pressure-sensitive adhesive polymer as the main component. For example, the ratio of the pressure-sensitive adhesive polymer in the pressure-sensitive adhesive composition may be 55 wt % or more, 60 wt % or more, 65 wt % or more, 70 wt % or more, 75 wt % or more, 80 wt % or more, 85 wt % or more, 90 wt % or more, 95 wt % or more, 97 wt % or more, or 99 wt % or more or so. The upper limit of the content of the pressure-sensitive adhesive polymer in the pressure-sensitive adhesive is not particularly limited. For example, the pressure-sensitive adhesive polymer may be included in an amount of 100 wt % or less, or less than 100 wt % in the pressure-sensitive adhesive.

In the present application, a specific acrylic copolymer may be applied as the pressure-sensitive adhesive polymer in order to form the specific pressure-sensitive adhesive.

For example, as the acrylic copolymer, an acrylic copolymer exhibiting crystallinity may be applied. In the present application, the matter that the acrylic copolymer exhibits crystallinity means that a melting point (Tm) is confirmed in the DSC (Differential Scanning Calorimeter) measurement method described in Examples of this specification. In this specification, melting point and melting temperature have the same meaning.

Acrylic copolymers are generally amorphous. In the present application, crystallinity is imparted to the copolymer through control of the monomer units of the acrylic copolymer.

In the present application, as the acrylic copolymer, a copolymer having a glass transition temperature (Tg) and a melting point simultaneously may be used, thereby effectively forming a desired pressure-sensitive adhesive. Here, the matter of having the glass transition temperature and the melting point simultaneously means that the glass transition temperature and the melting point are simultaneously confirmed in the DSC (Differential Scanning Calorimeter) measurement method.

In order to secure desired properties, the melting point and the glass transition temperature may be adjusted.

For example, the upper limit of the glass transition temperature of the acrylic copolymer may be −30° C., −35° C., −40° C., −45° C., −50° C., −55° C., or −60° C. or so, and the lower limit thereof may be −100° C., −90° C., −80° C., −70° C., or −65° C. or so. The glass transition temperature may be less than or equal to, or less than any one of the above-described upper limits, or may be more than or equal to, or more than any one of the above-described lower limits while being less than or equal to, or less than any one of the above-described upper limits.

The upper limit of the melting point of the acrylic copolymer may be −10° C., −15° C., −20° C., −25° C., −30° C., −35° C., or −40° C. or so, and the lower limit thereof may also be −80° C., −75° C., −70° C., −65° C., −60° C., −55° C., −50° C., or −45° C. or so. The melting point may be less than or equal to, or less than any one of the above-described upper limits, or may be more than or equal to, or more than any one of the above-described lower limits while being less than or equal to, or less than any one of the above-described upper limits.

A difference between the melting point (Tm) and the glass transition temperature (Tg) of the acrylic copolymer may be within a predetermined range. The difference is a value (Tm−Tg) obtained by subtracting the glass transition temperature (Tg) from the melting point (Tm). The lower limit of the difference may be 5° C., 10° C., or 15° C. or so, and the upper limit thereof may be 100° C., 95° C., 90° C., 85° C., 80° C., 75° C., 70° C., 65° C., 60° C., 55° C., 50° C., 45° C., 40° C., 35° C., 30° C., 25° C., or 20° C. or so. The difference between the melting point (Tm) and the glass transition temperature (Tg) may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits.

Through the application of an acrylic copolymer exhibiting these properties, it is possible to efficiently secure desired properties.

For securing suitable properties, the weight average molecular weight of the acrylic copolymer may be adjusted. The weight average molecular weight and the molecular weight distribution to be described below are measured by GPC (gel permeation chromatography) described herein.

The lower limit of the weight average molecular weight of the acrylic copolymer may be 1,000,000, 1,100,000, 1,200,000, 1,300,000, 1,400,000, or 1,500,000 or so, and the upper limit thereof may be 5,000,000, 4,000,000, 3,000,000, 2,500,000, 2,000,000, or 1,900,000, 1,800,000, 1,700,000, 1,600,000, or 1,550,000 or so. The weight average molecular weight may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits.

The acrylic copolymer may have a molecular weight distribution within a predetermined range. In addition, it may be appropriate that the acrylic copolymer is cross-linked by an appropriate cross-linking agent according to the molecular weight distribution to be included in the pressure-sensitive adhesive. The molecular weight distribution is the value (Mw/Mn) obtained by dividing the weight average molecular weight (Mw) by the number average molecular weight (Mn). In general, as the molecular weight distribution is smaller, it is recognized that the ratio of components with a relatively small molecular weight and components with a relatively high molecular weight, based on the average molecular weight, in the copolymer is small, the composition of the copolymer is uniform, and rheological properties such as an elastic modulus are stable. However, physical properties suitable for flexible devices include properties opposite to each other, such as followability and recoverability to deformation, and the followability, and cuttability and reliability, whereby in order to stably secure these properties, it may be necessary to adjust the molecular weight distribution depending on the type of the applied cross-linking agent.

In one example, when the acrylic copolymer is cross-linked by a thermal cross-linking agent to be described below and included, the lower limit of the molecular weight distribution may be 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5.0 or so, and the upper limit thereof may be 10, 9.5, 9, 8.5, 8, 7.5, 7, 6.5, 6, or 5.5 or so. The molecular weight distribution may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a thermal cross-linking agent to be described below. It may be appropriate for this type of acrylic copolymer to be cross-linked only by the thermal cross-linking agent. For example, when the acrylic copolymer is cross-linked only by the thermal cross-linking agent, or also cross-linked by simultaneously applying the thermal cross-linking agent and the radical cross-linking agent, it may be appropriate that the ratio (B/A) of the weight (A) of the used thermal cross-linking agent and the weight (B) of the radical cross-linking agent is below a certain level. For example, the upper limit of the weight ratio B/A may be 0.5, 0.4, 0.3, 0.2, 0.1, 0.09, 0.08, 0.07, 0.06, 0.05, 0.04, 0.03, 0.02, 0.01, 0.009, 0.008, 0.007, 0.006, 0.006, 0.005, 0.004, 0.003, 0.002, 0.001, 0.0009, 0.0008, 0.0007, 0.0006, 0.0005, 0.0004, 0.0003, 0.0002, or 0.0001 or so, and the lower limit thereof may be 0 or so. The ratio B/A may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a radical cross-linking agent to be described below.

In one example, when the acrylic copolymer is cross-linked by a radical cross-linking agent to be described below and included, the lower limit of the molecular weight distribution may be 0.5, 1, 1.5, or 2 or so, and the upper limit thereof may be 3, 2.8, 2.6, or 2.4 or so. The molecular weight distribution may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a radical cross-linking agent to be described below. It may be suitable for forming a desired type of pressure-sensitive adhesive that the acrylic copolymer with such a molecular weight distribution is cross-linked by a thermal cross-linking agent to be described below. It may be appropriate that the acrylic copolymer with such a type is cross-linked only by the radical cross-linking agent. For example, when the acrylic copolymer is cross-linked only by the radical cross-linking agent, or also cross-linked by simultaneously applying the thermal cross-linking agent and the radical cross-linking agent, it may be appropriate that the ratio (C/D) of the weight (C) of the used thermal cross-linking agent and the weight (D) of the radical cross-linking agent is below a certain level. For example, the upper limit of the weight ratio C/D may be 0.5, 0.4, 0.3, 0.2, 0.1, 0.09, 0.08, 0.07, 0.06, 0.05, 0.04, 0.03, 0.02, 0.01, 0.009, 0.008, 0.007, 0.006 0.005, 0.004, 0.003, 0.002, 0.001, 0.0009, 0.0008, 0.0007, 0.0006, 0.0005, 0.0004, 0.0003, 0.0002, or 0.0001 or so, and the lower limit thereof may be 0 or so. The ratio C/D may be less than or equal to, or less than any one of the above-described upper limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a radical cross-linking agent to be described below.

The method of adjusting the molecular weight distribution of the acrylic copolymer itself is known, and for example, the molecular weight distribution can be controlled through one or more methods selected from use of a molecular weight modifier, adjustment of an initiator ratio and/or adjustment of a polymerization time, and the like.

Such an acrylic copolymer may comprise at least an alkyl (meth)acrylate unit, a unit of Formula 1 below, and a polar functional group-containing unit.

Here, the unit means a monomer unit.

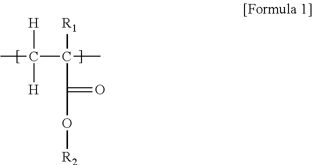

In Formula 1, R₁ represents hydrogen or an alkyl group, and R₂ represents an alkyl group with 11 to 13 carbon atoms.

The acrylic copolymer containing the above monomer units is effective in forming a desired pressure-sensitive adhesive.

The acrylic copolymer may be formed of the above-described crystalline copolymer under a predetermined ratio of the unit of Formula 1 and/or the polar functional group-containing unit, or maybe formed of a copolymer having properties similar thereto. In addition, by forming such a crystalline copolymer to have the above-described molecular weight distribution, it is possible to obtain a pressure-sensitive adhesive effectively satisfying desired properties.

For example, when the unit of Formula 1 above is present in a predetermined ratio, and in some cases, when the unit of Formula 1 above interacts with the polar functional group present in a predetermined ratio, such a copolymer may exhibit crystallinity, or may exhibit at least properties similar to crystallinity. As such, when a copolymer having crystallinity or exhibiting properties similar to crystallinity is applied, the pressure-sensitive adhesive having the above-described properties can be efficiently formed. Therefore, it is possible to effectively form a pressure-sensitive adhesive exhibiting the above-described elastic modulus characteristics through the pressure-sensitive adhesive to which such a copolymer is applied.

As the alkyl (meth)acrylate unit contained in the copolymer, for example, a unit derived from an alkyl (meth)acrylate having an alkyl group with 1 to 10 carbon atoms may be used. In another example, the alkyl group may be an alkyl group with 2 to 20 carbon atoms, 3 to 10 carbon atoms, 4 to 10 carbon atoms, 4 to 10 carbon atoms, 4 to 9 carbon atoms, or 4 to 8 carbon atoms. The alkyl group may be linear or branched, which may be substituted or unsubstituted. In one example, the unit may be formed using an alkyl (meth)acrylate having an unsubstituted alkyl group while being linear or branched as the alkyl group.

An example of the alkyl (meth)acrylate may be exemplified by methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, isononyl (meth)acrylate, n-octyl (meth)acrylate or isooctyl (meth)acrylate, and the like, but is not limited thereto.

The acrylic copolymer may comprise the alkyl (meth)acrylate unit in a predetermined ratio. For example, the lower limit of the content of the unit in the copolymer may be about 10 wt %, 15 wt %, 20 wt %, 25 wt %, 30 wt %, 35 wt %, or 40 wt % or so, and the upper limit thereof may be 60 wt %, 55 wt %, 50 wt %, 45 wt %, or 40 wt % or so. Within this range, a desired pressure-sensitive adhesive can be effectively formed. The ratio may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits.

The polar functional group-containing unit is a unit formed of a monomer having a polar functional group. Such a monomer usually comprises a polymerizable group (e.g., a carbon-carbon double bond) and a polar functional group simultaneously.

The monomer having a polar functional group may include a hydroxyl group-containing monomer, a carboxyl group-containing monomer, and a nitrogen-containing monomer, and the like, and in the present application, it is particularly advantageous to apply a hydroxyl group-containing monomer, but is not limited thereto.

The hydroxyl group-containing monomer may include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxypolyethylene glycol (meth)acrylate, or 2-hydroxypolypropylene glycol (meth)acrylate, and the like; an example of the carboxyl group-containing monomer may include (meth)acrylic acid, 2-(meth)acryloyloxyacetic acid, 3-(meth)acryloyloxypropyl acid, 4-(meth)acryloyloxybutyric acid, acrylic acid dimer, itaconic acid, maleic acid and maleic acid anhydride, and the like; and an example of the nitrogen-containing monomer may include (meth)acrylamide, N-vinyl pyrrolidone, or N-vinyl caprolactam, and the like, without being limited thereto. One or a mixture of two or more of the foregoing may be used.

In one example, as the polar functional group-containing unit, a hydroxy-containing monomer unit may be applied, and specifically, a hydroxyalkyl (meth)acrylate unit may be applied, where a hydroxyalkyl (meth)acrylate unit, in which the alkyl of the hydroxyalkyl moiety has 1 to 20, 1 to 16, 1 to 12, 1 to 8, 1 to 4, or 2 to 4 carbon atoms, may be employed. Here, the alkyl of the hydroxyalkyl moiety may be linear or branched.

The lower limit of parts by weight of the polar functional group-containing unit relative to 100 parts by weight of the alkyl (meth)acrylate unit may be 10 parts by weight, 15 parts by weight, 20 parts by weight, 25 parts by weight, 30 parts by weight, 35 parts by weight, 40 parts by weight, 45 parts by weight, or 50 parts by weight or so, and the upper limit thereof may be 200 parts by weight, 195 parts by weight, 190 parts by weight, 185 parts by weight, 180 parts by weight, 175 parts by weight, 170 parts by weight, 165 parts by weight, 160 parts by weight. 155 parts by weight, 150 parts by weight, 145 parts by weight, 140 parts by weight, 135 parts by weight, 130 parts by weight, 125 parts by weight, 120 parts by weight, 115 parts by weight, 110 parts by weight, 105 parts by weight, 100 parts by weight, 95 parts by weight, 90 parts by weight, 85 parts by weight, 80 parts by weight, 75 parts by weight, 70 parts by weight, 65 parts by weight, 60 parts by weight, 55 parts by weight, 50 parts by weight, 45 parts by weight, 40 parts by weight, or 38 parts by weight or so. The ratio may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. Under such a ratio, it is possible to stably maintain the durability, pressure-sensitive adhesiveness, and peeling force of the pressure-sensitive adhesive.

The unit of Formula 1 is a unit containing a long-chain alkyl group, and such a unit is included in the copolymer in a certain ratio or more, and in some cases, it interacts with a polar functional group as necessary, whereby it is possible to impart crystallinity or properties similar to crystallinity to the copolymer.

In the unit of Formula 1, R₁ may be hydrogen or an alkyl group with 1 to 4 carbon atoms, and may be specifically hydrogen, or a methyl or ethyl group.

In Formula 1, R₂ is an alkyl group with 11 to 13 carbon atoms, where such an alkyl group may be linear or branched, and may be substituted or unsubstituted. In one example, the R₂ may be an unsubstituted alkyl group while being linear. For example, the unit of Formula 1 may be formed using lauryl (meth)acrylate and/or tetradecyl (meth)acrylate, and the like.

The lower limit of parts by weight of the unit of Formula 1 relative to 100 parts by weight of the alkyl (meth)acrylate unit may be 80 parts by weight, 85 parts by weight, 90 parts by weight, 95 parts by weight, 100 parts by weight, 105 parts by weight, 110 parts by weight, 115 parts by weight, 120 parts by weight, 125 parts by weight, 130 parts by weight, 135 parts by weight, 140 parts by weight, 145 parts by weight, 150 parts by weight, 155 parts by weight, 160 parts by weight, 175 parts by weight, 180 parts by weight, 185 parts by weight, 190 parts by weight, 195 parts by weight, 200 parts by weight, 205 parts by weight, 210 parts by weight, 215 parts by weight, 220 parts by weight, 225 parts by weight, 230 parts by weight, 235 parts by weight, 240 parts by weight, 245 parts by weight, 250 parts by weight, 255 parts by weight, 260 parts by weight, 275 parts by weight, 280 parts by weight, 285 parts by weight, 290 parts by weight, 295 parts by weight, or 300 parts by weight or so, and the upper limit thereof may also be 600 parts by weight, 595 parts by weight, 590 parts by weight, 585 parts by weight, 580 parts by weight, 575 parts by weight, 570 parts by weight, 565 parts by weight, 560 parts by weight, 555 parts by weight, 550 parts by weight, 545 parts by weight, 540 parts by weight, 535 parts by weight, 530 parts by weight, 525 parts by weight, 520 parts by weight, 515 parts by weight, 510 parts by weight, 505 parts by weight, 500 parts by weight, 495 parts by weight, 490 parts by weight, 485 parts by weight, 480 parts by weight, 475 parts by weight, 470 parts by weight, 465 parts by weight, 460 parts by weight, 455 parts by weight, 450 parts by weight, 445 parts by weight, 440 parts by weight, 435 parts by weight, 430 parts by weight, 425 parts by weight, 420 parts by weight, 415 parts by weight, 410 parts by weight, 405 parts by weight, 400 parts by weight, 395 parts by weight, 390 parts by weight, 385 parts by weight, 380 parts by weight, 375 parts by weight, 370 parts by weight, 365 parts by weight, 360 parts by weight, 355 parts by weight, 350 parts by weight, 345 parts by weight, 340 parts by weight, 335 parts by weight, 330 parts by weight, 325 parts by weight, 320 parts by weight, 315 parts by weight, 310 parts by weight, 305 parts by weight, 300 parts by weight, 295 parts by weight, 290 parts by weight, 285 parts by weight, 280 parts by weight, 275 parts by weight, 270 parts by weight, 265 parts by weight, 260 parts by weight, 255 parts by weight, 250 parts by weight, 245 parts by weight, 240 parts by weight, 235 parts by weight, 230 parts by weight, 225 parts by weight, 220 parts by weight, 215 parts by weight, 210 parts by weight, 205 parts by weight, 200 parts by weight, 195 parts by weight, 190 parts by weight, 185 parts by weight, 180 parts by weight, 175 parts by weight, 170 parts by weight, 165 parts by weight, 160 parts by weight, 155 parts by weight, 150 parts by weight, 145 parts by weight, 140 parts by weight, 135 parts by weight, 130 parts by weight, 125 parts by weight, 120 parts by weight, 115 parts by weight, 110 parts by weight, 105 parts by weight, or 100 parts by weight or so. The ratio may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits.

The ratio of monomer units may be adjusted so that the acrylic copolymer exhibits the above-described glass transition temperature and melting point simultaneously.

That is, the acrylic copolymer containing the three types of monomer units as described above in a predetermined ratio has crystallinity or tends to exhibit properties similar to crystallinity, but in order to have the above-described melting point and glass transition temperature simultaneously, the composition of the acrylic copolymer may be further adjusted.

For example, in order for the acrylic copolymer to exhibit the above-described crystallinity, it is necessary to include at least 80 parts by weight or more of the unit of Formula 1 among the above-described units relative to 100 parts by weight of the alkyl (meth)acrylate unit. In another example, the ratio of the unit of Formula 1 above in the crystalline acrylic copolymer may be 85 parts by weight or more, 95 parts by weight or more, or 100 parts by weight or more or so, or may also be 500 parts by weight or less, 495 parts by weight or less, 490 parts by weight or less, 485 parts by weight or less, 480 parts by weight or less, 475 parts by weight or less, 470 parts by weight or less, 465 parts by weight or less, 460 parts by weight or less, 455 parts by weight or less, 450 parts by weight or less, 445 parts by weight or less, 440 parts by weight or less, 435 parts by weight or less, 430 parts by weight or less, 425 parts by weight or less, 420 parts by weight or less, 415 parts by weight or less, 410 parts by weight or less, 405 parts by weight or less, 400 parts by weight or less, 395 parts by weight or less, 390 parts by weight or less, 385 parts by weight or less, 380 parts by weight or less, 375 parts by weight or less, 370 parts by weight or less, 365 parts by weight or less, 360 parts by weight or less, 355 parts by weight or less, 350 parts by weight or less, 345 parts by weight or less, 340 parts by weight or less, 335 parts by weight or less, 330 parts by weight or less, 325 parts by weight or less, 320 parts by weight or less, 315 parts by weight or less, 310 parts by weight or less, 305 parts by weight or less, 300 parts by weight or less, 295 parts by weight or less, 290 parts by weight or less, 285 parts by weight or less, 280 parts by weight or less, 275 parts by weight or less, 270 parts by weight or less, 265 parts by weight or less, 260 parts by weight or less, 255 parts by weight or less, 250 parts by weight or less, 245 parts by weight or less, 240 parts by weight or less, 235 parts by weight or less, 230 parts by weight or less, 225 parts by weight or less, 220 parts by weight or less, 215 parts by weight or less, 210 parts by weight or less, 205 parts by weight or less, 200 parts by weight or less, 195 parts by weight or less, 190 parts by weight or less, 185 parts by weight or less, 180 parts by weight or less, 175 parts by weight or less, 170 parts by weight or less, 165 parts by weight or less, 160 parts by weight or less, 155 parts by weight or less, 150 parts by weight or less, 145 parts by weight or less, 140 parts by weight or less, 135 parts by weight or less, 130 parts by weight or less, 125 parts by weight or less, 120 parts by weight or less, 115 parts by weight or less, 110 parts by weight or less, 105 parts by weight or less, or 100 parts by weight or less or so, relative to 100 parts by weight of the alkyl (meth)acrylate unit.

In the crystalline acrylic copolymer, the ratio (A/B) of the weight (A) of the unit of Formula 1 and the weight (B) of the polar functional group-containing unit may be 1.5 or more. In another example, the ratio (A/B) may be 1.7 or more, 1.9 or more, 2.1 or more, 2.3 or more, or 2.5 or more or so, or may also be 10 or less, 9 or less, 8 or less, 7 or less, 6 or less, 5 or less, 4 or less, or 3 or less or so. Also, in the crystalline acrylic copolymer, the polar functional group-containing unit may be a hydroxy group-containing unit. In one example, a hydroxyalkyl (meth)acrylate having a hydroxyalkyl group with 3 to 6 carbon atoms, 3 to 5 carbon atoms, 3 to 4 carbon atoms, or about 4 carbon atoms may suitably form the crystalline acrylic copolymer. Although the reason is not clear, it is thought that the interaction between the alkyl group (R₂) of the unit of Formula 1 and the hydroxyalkyl group contributes to the expression of crystallinity of the acrylic copolymer.

The crystalline acrylic copolymer may comprise the alkyl (meth)acrylate unit in a ratio within the range of about 15 to 55 wt %. In another example, the ratio of the alkyl (meth)acrylate unit may be 20 wt % or more, 25 wt % or more, 30 wt % or more, 35 wt % or more, or 40 wt % or more or so, or may also be 50 wt % or less, or 45 wt % or less or so. Within this range, it is possible to effectively form a desired pressure-sensitive adhesive.

It is thought that the crystallinity is provided to the acrylic copolymer and the melting point is identified by the interaction or regularity of the respective monomer units contained in the ratio.

The acrylic copolymer may appropriately contain other monomer units in addition to the above-described monomer units, as long as the purpose is not impaired.

For example, the acrylic copolymer may further comprise a monomer unit of Formula 2 below. The monomer unit of Formula 2 below is an optional monomer unit, which may not be included in the acrylic copolymer.

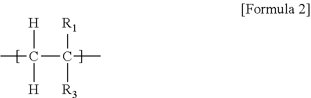

In Formula 2, R₁ represents hydrogen or an alkyl group, and R₃ is an aromatic ketone group or a (meth)acryloyl group.

The unit of Formula 2 is a unit containing an aromatic ketone group or a (meth)acryloyl group in its side chain.

The aromatic ketone group or (meth)acryloyl group in the pressure-sensitive adhesive may exist as such, or may also exist in a state after undergoing a hydrogen removal reaction or radical reaction described below.

The aromatic ketone group in the unit of Formula 2 means an aromatic ketone group that induces hydrogen removal (hydrogen abstraction) from a polymer chain when exposed to electromagnetic waves, or a substituent containing such an aromatic ketone group.

When exposed to electromagnetic waves, the aromatic ketone group can remove hydrogen atoms from other polymer chains or from other parts of the polymer chain. This removal results in the formation of radicals, where the radicals can form cross-links between polymer chains or within the same polymer chain. In the category of such aromatic ketone groups, for example, aromatic ketone groups such as derivatives of benzophenone, acetophenone, or anthraquinone are included.

The monomer capable of deriving the unit of Formula 2 having an aromatic ketone group includes 4-benzoylphenyl (meth)acrylate, 4-(meth)acryloyloxyethoxybenzophenone, 4-(meth)acryloyloxy-4′-methoxybenzophenone, 4-(meth)acryloyloxyethoxy-4′-methoxybenzophenone, 4-(meth)acryloyloxy-4′-bromobenzophenone and/or 4-acryloyloxyethoxy-4′-bromobenzophenone, and the like, but is not limited thereto.

The (meth)acryloyl group in the unit of Formula 2 means a (meth)acryloyl group that induces free radical polymerization when exposed to electromagnetic waves in the presence of an appropriate radical initiator, or a substituent comprising the same. Such a (meth)acryloyl group may act similarly to the aromatic ketone group by irradiation with electromagnetic waves.

The unit of Formula 2 in which R₃ is a (meth)acryloyl group, for example, may be formed by preparing a precursor copolymer and then further reacting it with an unsaturated reagent compound to introduce a (meth)acryloyl group. Typically, the introduction of the (meth)acryloyl group involves (1) a reaction between a nucleophilic group on the precursor copolymer and an electrophilic group on the unsaturated reagent compound (i.e., the unsaturated reagent compound contains both an electrophilic group and a (meth)acryloyl group), or (2) a reaction between an electrophilic group on the precursor copolymer and a nucleophilic group on the unsaturated reagent compound (i.e., the unsaturated reagent compound contains both nucleophilic groups and (meth)acryloyl groups). These reactions between nucleophilic groups and electrophilic groups are typically ring opening reactions, addition reactions or condensation reactions.

In this case, the precursor copolymer has a hydroxy, carboxylic acid (—COOH), or anhydride (—O—(CO)—O—) group. When the precursor copolymer has a hydroxyl group, the unsaturated reagent compound often has a carboxylic acid (—COOH), isocyanato (—NCO), epoxy (i.e., oxiranyl) or anhydride group in addition to the (meth)acryloyl group. When the precursor copolymer has a carboxylic acid group, the unsaturated reagent compound often has a hydroxy, amino, epoxy, isocyanato, aziridinyl, azetidinyl or oxazolinyl group in addition to the (meth)acryloyl group. When the precursor (meth)acrylate copolymer has an anhydride group, the unsaturated reagent compound often has a hydroxy or amine group in addition to the (meth)acryloyl group.

In one example, the precursor copolymer may have a carboxylic acid group and the unsaturated reagent compound may have an epoxy group. In an exemplary unsaturated reagent compound, for example, glycidyl (meth)acrylate and 4-hydroxybutyl acrylate glycidyl ether are included. In another example, the precursor copolymer has an anhydride group, and reacts with an unsaturated reagent compound which is a hydroxy-substituted alkyl (meth)acrylate, such as 2-hydroxyethyl (meth)acrylate, 3-hydroxypropyl (meth)acrylate, and the like. In another example, the precursor copolymer has a hydroxy group and the unsaturated reagent compound has an isocyanato group and a (meth)acryloyl group. Such an unsaturated reagent compound comprises an isocyanatoalkyl (meth)acrylate, such as isocyanatoethyl (meth)acrylate, but is not limited thereto.

In one example, the (meth)acryloyl group may be represented by the formula CH₂=CHR¹⁻(CO)-Q-L- (wherein, L is a linking group and Q is oxy (—O—) or —NH—). Here, L comprises alkylene, arylene, or a combination thereof, and further comprises —O—, —O—(CO)—, —NH—(CO)—, —NH—, or a combination thereof, optionally depending on the precursor copolymer and the specific unsaturated reagent compound, which are reacted to form the (meth)acryloyl group. In some specific examples, the (meth)acryloyl group is H₂C═CHR¹⁻(CO)—O—R⁶⁻NH—(CO)—O—R⁵⁻O—(CO)—, which is formed by a reaction of a hydroxy-containing group of the precursor copolymer represented by the formula —(CO)—O—R⁵—OH and the unsaturated reagent compound which is an isocyanatoalkyl (meth)acrylate represented by the formula H₂C═CHR¹⁻(CO)—O—R⁶⁻NCO. Here, R⁵ and R⁶ are each independently an alkylene group, for example, alkylene having 1 to 10 carbon atoms, 1 to 6 carbon atoms, or 1 to 4 carbon atoms. In addition, here, R¹ is methyl or hydrogen.

In the unit of Formula 2, R₁ may be hydrogen or an alkyl group with 1 to 4 carbon atoms, and specifically, may be hydrogen, or a methyl or ethyl group.

The unit of Formula 2, when included, may be included in the acrylic copolymer in a ratio of about 0.001 to 5 parts by weight relative to 100 parts by weight of the alkyl (meth)acrylate unit.

In a suitable example, the acrylic copolymer may not contain the unit of Formula 2 or may contain it in a relatively small amount, and under such a composition, it is possible to form a pressure-sensitive adhesive with desired physical properties more effectively. That is, the unit of Formula 2 above is a unit capable of forming a cross-linked structure in a pressure-sensitive adhesive by additional energy such as electromagnetic waves, but when such a unit exists at a certain level or more, the designed cross-linked structure of the pressure-sensitive adhesive may be changed, and rheological properties and the like may be damaged, so that in order to secure the desired characteristics, it may be more advantageous that the unit is not included.

Therefore, in one example, the upper limit of the ratio of the unit of Formula 2 above based on the total weight of the acrylic copolymer may be 0.1 wt %, 0.09 wt %, 0.08 wt %, 0.07 wt %, 0.06 wt %, 0.05 wt %, 0.04 wt %, 0.03 wt %, 0.02 wt %, 0.01 wt %, 0.009 wt %, 0.008 wt %, 0.007 wt %, 0.006 wt %, 0.005 wt %, 0.004 wt %, 0.003 wt %, 0.002 wt %, or 0.001 wt % or so, and the lower limit thereof may be 0 wt % or so. The ratio may be less than or equal to, or less than any one of the above-described upper limits, or may be in a range of less than or equal to, or less than any one of the above-described upper limits while being more than or equal to, or more than any one of the above-described lower limits.

In another example, the upper limit of the ratio of the unit of Formula 2 above to 100 parts by weight of the alkyl (meth)acrylate unit may be 0.2 parts by weight, 0.15 parts by weight, 0.1 parts by weight, 0.05 parts by weight, 0.01 parts by weight, 0.005 parts by weight, 0.004 parts by weight, 0.003 parts by weight, 0.002 parts by weight, 0.001 parts by weight, 0.00095 parts by weight, or 0.0009 parts by weight or so, and the lower limit thereof may be 0 parts by weight or so. The ratio may be less than or equal to, or less than any one of the above-described upper limits, or may be in a range of less than or equal to, or less than any one of the above-described upper limits while being more than or equal to, or more than any one of the above-described lower limits.

The pressure-sensitive adhesive layer may further comprise a cross-linking agent. The cross-linking agent may react with the acrylic copolymer to realize a cross-linked structure.

The type of the cross-linking agent is not particularly limited, and for example, a general cross-linking agent such as an isocyanate-based compound, an epoxy-based compound, an aziridine-based compound, and a metal chelate-based compound may be used. This type of cross-linking agent is a so-called thermal cross-linking agent that implements a cross-linked structure by application of heat, and is different from a radical cross-linking agent to be described below. Such a cross-linking agent may be selected depending on the molecular weight distribution of the acrylic copolymer according to the above-described contents. A specific example of the isocyanate-based compound may include one or more selected from the group consisting of tolylene diisocyanate, xylene diisocyanate, diphenylmethane diisocyanate, hexamethylene diisocyanate, isophorone diisocyanate, tetramethylxylene diisocyanate, naphthalene diisocyanate, and a reactant of any one of the foregoing with a polyol (e.g., trimethylol propane); a specific example of the epoxy compound may include one or more selected from the group consisting of ethylene glycol diglycidyl ether, triglycidyl ether, trimethylolpropane triglycidyl ether, N,N,N′,N′-tetraglycidyl ethylenediamine and glycerin diglycidyl ether; and a specific example of the aziridine-based compound may include one or more selected from the group consisting of N,N′-toluene-2,4-bis(1-aziridinecarboxamide), N,N′-diphenylmethane-4,4′-bis(1-aziridinecarboxamide), triethylene melamine, bisisoprotaloyl-1-(2-methylaziridine), and tri-1-aziridinylphosphine oxide, without being limited thereto. In addition, here, a specific example of the metal chelate-based compound may include a compound in which a polyvalent metal such as aluminum, iron, zinc, tin, titanium, antimony, magnesium and/or vanadium is coordinated with acetyl acetone or ethyl acetoacetate, and the like, but is not limited thereto.

In the pressure-sensitive adhesive, the lower limit of parts by weight of the thermal cross-linking agent relative to 100 parts by weight of the acrylic copolymer may be 0.01 parts by weight, 0.02 parts by weight, 0.03 parts by weight, 0.04 parts by weight, 0.05 parts by weight, 0.06 parts by weight, or 0.07 parts by weight or so, and the upper limit thereof may also be 20 parts by weight, 15 parts by weight, 10 parts by weight, 5 parts by weight, 4 parts by weight, 3 parts by weight, 2 parts by weight, 1 part by weight, 0.8 parts by weight, 0.6 parts by weight, 0.4 parts by weight, 0.2 parts by weight, 0.15 parts by weight, 0.1 parts by weight, or 0.09 parts by weight or so. The ratio may be less than or equal to, or less than any one of the above-described upper limits, may be more than or equal to, or more than any one of the above-described lower limits, or may be less than or equal to, or less than any one of the above-described upper limits while being more than or equal to, or more than any one of the above-described lower limits.

When the content of the cross-linking agent is selected to cross-link the acrylic copolymer at an appropriate level within the content range, it is possible to effectively form the desired pressure-sensitive adhesive.

The pressure-sensitive adhesive may comprise, as the cross-linking agent, a so-called radical cross-linking agent which is a cross-linking agent of a different type from the thermal cross-linking agent. Such a cross-linking agent implements a cross-linked structure by a radical reaction. Such a cross-linking agent may also be selected according to the molecular weight distribution of the above-descried acrylic copolymer. It may be more advantageous to apply a radical cross-linking agent as above for efficient achievement of desired properties. Such a radical cross-linking agent may be exemplified by a so-called polyfunctional acrylate, which may include, for example, bifunctional acrylates such as 1,4-butanediol di(meth)acrylate, 1,6-hexanediol di(meth)acrylate, neopentylglycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecanedimethanol (meth)acrylate, dimethylol dicyclopentane di(meth)acrylate, ethylene oxide-modified hexahydrophthalic acid di(meth)acrylate, tricyclodecane dimethanol (meth)acrylate, neopentyl glycol-modified trimethylpropane di(meth)acrylate, adamantane di(meth)acrylate or 9,9-bis[4-(2-acryloyloxyethoxy)phenyl]fluorene; trifunctional acrylates such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylate, or tris(meth)acryloxyethyl isocyanurate; tetrafunctional acrylates such as diglycerin tetra(meth)acrylate or pentaerythritol tetra(meth)acrylate; pentafunctional acrylates such as propionic acid-modified dipentaerythritol penta(meth)acrylate; and hexafunctional acrylates such as dipentaerythritol hexa(meth)acrylate, caprolactone-modified dipentaerythritol hexa(meth)acrylate or urethane (meth)acrylate (e.g., a reactant of an isocyanate monomer and trimethylol propane tri(meth)acrylate, etc.), and the like, but is not limited thereto.

In the pressure-sensitive adhesive layer, the radical cross-linking agent may also be present in an appropriate ratio depending on the purpose, and for example, the lower limit of the weight ratio of the radical cross-linking agent relative to 100 parts by weight of the acrylic copolymer may be 0.001 parts by weight, 0.005 parts by weight, 0.01 parts by weight, 0.02 parts by weight, 0.03 parts by weight, 0.04 parts by weight, or 0.05 parts by weight or so, and the upper limit thereof may be 10 parts by weight, 9.5 parts by weight, 9 parts by weight, 8.5 parts by weight, 8 parts by weight, 7.5 parts by weight, 7 parts by weight. 6.5 parts by weight, 6 parts by weight, 5.5 parts by weight, 5 parts by weight, 4.5 parts by weight, 4 parts by weight, 3.5 parts by weight, 3 parts by weight, 2.5 parts by weight, 2 parts by weight, 1.5 parts by weight, 1 part by weight, 0.9 parts by weight, 0.8 parts by weight, 0.7 parts by weight, 0.6 parts by weight, 0.5 parts by weight, 0.4 parts by weight, 0.3 parts by weight, 0.2 parts by weight, 0.1 parts by weight, 0.09 parts by weight, 0.08 parts by weight, 0.07 parts by weight, 0.06 parts by weight, or 0.05 parts by weight or so. The ratio may be less than or equal to, or less than any one of the above-described upper limits, or may be more than or equal to, or more than any one of the above-described lower limits, or may be in a range of less than or equal to, or less than the above-described upper limit while being more than or equal to, or more than any one of the above-described lower limits.

In addition to the above components, the pressure-sensitive adhesive may comprise appropriate additional components as needed, which may also comprise, for example, components of a radical initiator, an ultraviolet absorber, a light stabilizer, a plasticizer, and/or a cross-linking catalyst, and the like.

However, the pressure-sensitive adhesive may not comprise a citric acid ester-based compound, for example, a citric acid ester-based compound whose terminal is substituted with hydrogen or an alkyl group, or even if it is included, the content thereof may be limited to a certain level or less. Although the reason is not clear, such a citric acid ester-based compound allows the cross-linked structure of the pressure-sensitive adhesive to be adjusted differently from the desired level, whereby it is difficult to secure desired physical properties.

In one example, the upper limit of the weight ratio of the citric acid ester-based compound relative to 100 parts by weight of the acrylic copolymer may be 5 parts by weight, 4.5 parts by weight, 4 parts by weight, 3.5 parts by weight, 3 parts by weight, 2.5 parts by weight, 2 parts by weight, 1.5 parts by weight, 1 part by weight, or 0.5 parts by weight or so, and the lower limit thereof may be 0 parts by weight, 0.5 parts by weight, 1 part by weight, 1.5 parts by weight, 2 parts by weight, 2.5 parts by weight, or 3 parts by weight or so. The ratio may be less than or equal to, or less than any one of the above-described upper limits, or may be in a range of less than or equal to, or less than the above-described upper limit while being more than or equal to, or more than any one of the above-described lower limits.

The pressure-sensitive adhesive may be formed by cross-linking the pressure-sensitive adhesive composition comprising such components. A method of forming the pressure-sensitive adhesive layer by cross-linking is not particularly limited, where the pressure-sensitive adhesive may be formed by applying an appropriate cross-linking method in consideration of the type of the pressure-sensitive adhesive polymer and/or cross-linking agent. For example, if the polymer and/or cross-linking agent is a type cross-linked by application of heat, a cross-linked product may be formed by applying appropriate heat, and if it is a type cross-linked by irradiation of electromagnetic waves, a cross-linked product may be formed by irradiating it with appropriate electromagnetic waves, and other cross-linking methods may also be applied.

Such an adhesive may exhibit the above-described characteristics.

Such a pressure-sensitive adhesive of the present application may be in the form of a layer. In this case, the thickness of the pressure-sensitive adhesive layer is not particularly limited, where it may have a thickness of a typical pressure-sensitive adhesive layer in consideration of the applied use. In general, the thickness of the pressure-sensitive adhesive layer may be determined within a range of 5 μm to 100 μm, but is not limited thereto.

The present application also relates to a pressure-sensitive adhesive film or an optical laminate, comprising a base film and the pressure-sensitive adhesive formed on one side or both sides of the base film. In the case of the optical laminate, the base film may be an optical film. The pressure-sensitive adhesive may be included in the form of a layer.

The pressure-sensitive adhesive of the present application may be formed on one side or both sides of the base film to form a pressure-sensitive adhesive film, or formed on one side or both sides of the base film, which is an optical film, to form an optical laminate.

The type of the base film is not particularly limited. As the base film, a base film which is applicable to the formation of the pressure-sensitive adhesive film may be usually applied.

For example, as the base film, a PET (poly(ethylene terephthalate)) film, a PTFE (poly(tetrafluoroethylene)) film, a PP (polypropylene) film, a PE (polyethylene) film, a polyimide film, a polyamide film, a COP (cyclic olefin polymer) film, a polybutene film, a polybutadiene film, a vinyl chloride copolymer film, a polyurethane film, an ethylene-vinyl acetate film, an ethylene-propylene copolymer film, an ethylene-ethyl acrylate copolymer film, an ethylene-methyl acrylate copolymer film and/or a polyimide film, and the like may be used, without being limited thereto.

The thickness of the base film is not particularly limited, and it may have an appropriate thickness within a range suitable for the purpose.

When the optical film is applied as the base film, there is no particular limitation on the type of the optical film. In one example, the optical film may be a polarizing film, a polarizing plate, or a retardation film, and the like. Even in this case, the optical film may have a thickness in an appropriate range depending on the purpose.

The pressure-sensitive adhesive film or the optical laminate may further comprise a release film or a protective film for protecting the pressure-sensitive adhesive layer until use, if necessary.

The present application also relates to a flexible device comprising the pressure-sensitive adhesive, the pressure-sensitive adhesive film, or the optical laminate. Here, the pressure-sensitive adhesive may be included in the form of a layer. In the device, there is no particular limitation on the application form of the pressure-sensitive adhesive, the pressure-sensitive adhesive film, or the optical laminate. For example, the pressure-sensitive adhesive may be used for the application of a so-called OCA (Optically Clear Adhesive) or OCR (Optically Clear Resin) in the device, and thus the application form of the pressure-sensitive adhesive, the pressure-sensitive adhesive film, or the optical laminate may be the same as the application form of the conventional OCA or OCR.

In this case, in one example, the flexible device may comprise a display panel and the pressure-sensitive adhesive, pressure-sensitive adhesive film, or optical laminate present on one or both sides of the display panel. In this case, the display panel may be configured to be folded or rolled through one or more folding shafts or rolling shafts.

Other elements constituting such a flexible device are not particularly limited, where well-known components of the flexible device may be employed without limitation.

### Advantageous Effects

The present application can provide a pressure-sensitive adhesive suitable for a flexible device, and a device comprising the same. In one example, the present application can provide a pressure-sensitive adhesive that is applied to a flexible device to effectively respond to repeated deformation and recovery, does not cause defects before and after deformation, and has excellent recoverability, cuttability, workability, and reliability, and the like as well. The present application can also provide a pressure-sensitive adhesive film or an optical film, and a flexible device such as a foldable device or a rollable device, comprising the pressure-sensitive adhesive.

### BRIEF DESCRIPTION OF DRAWINGS

FIG. 1 is a diagram showing a process in which a folding test is performed.

### MODE FOR INVENTION

Hereinafter, the present application will be described in detail through Examples and Comparative Examples, but the scope of the present application is not limited by Examples below.

### 1. Measurement of Elastic Modulus and Maximum Stress

The elastic modulus of the pressure-sensitive adhesive layer was evaluated using ARES G2 (Advanced Rheometric Expansion System G2) (TA). A pressure-sensitive adhesive layer sample with a thickness of about 800 μm was cut into a circular shape with a diameter of about 8 mm or so to prepare a specimen. The pressure-sensitive adhesive layer sample was prepared by laminating 32 pressure-sensitive adhesive layers with a thickness of about 25 μm or so. The elastic modulus at the measurement temperature was evaluated for the specimen using a parallel plate fixture (diameter: about 8 mm). Specifically, the stress applied to the pressure-sensitive adhesive is measured while applying a shear force so that a constant strain is generated on the specimen, and the maximum stress (STS_{MAX}) and minimum stress (STS_{MIN}) in a section where the change in stress according to the strain is linear (linear section, section in strains of 0.7% to 4%) are obtained. Young's Modulus can be obtained by substituting the obtained maximum stress (STS_{MAX}) and minimum stress (STS_{MIN}) into Equation A below. The strain change was performed by setting the device so that strains from a strain of 0% to a strain of 400% were constantly generated for 1 second.

$$Elastic modulus ( Young ’ s Modulus ) ( Unit \text{:} Pa ) = 100 \times ( {STS}_{MAX} - {STS}_{MIN} ) / ( {STN}_{MAX} - {STN}_{MIN} ) \qquad [ Equation A ]$$

In Equation A, STS_{MAX} is the maximum stress (unit: Pa) applied to the pressure-sensitive adhesive within the linear section, and STS_{MIN} is the minimum stress (unit: Pa) applied to the pressure-sensitive adhesive within the linear section, and STN_{MAX} is the strain (unit: %) that the maximum stress is identified, and STN_{MIN} is the strain (unit: %) that the minimum stress is identified.

### 2. Stress-Relaxation Measurement

Stress-relaxation of the pressure-sensitive adhesive was evaluated using ARES G2 (Advanced Rheometric Expansion System G2) (TA). A pressure-sensitive adhesive layer sample with a thickness of about 800 μm or so was cut into a circular shape with a diameter of about 8 mm or so to prepare a specimen. The pressure-sensitive adhesive layer sample was prepared by laminating 32 pressure-sensitive adhesive layers with a thickness of about 25 μm or so to have the above thickness. The Stress-Relaxation was evaluated using a parallel plate fixture (diameter: about 8 mm). The device was set so that a strain of 100% occurred within 0.05 seconds, and a shear force was applied. The specimen was loaded into the equipment and the equipment was driven so that the strain of 100% was applied according to the setting. While maintaining the state where the equipment was driven, and the strain of 100% was applied, the stress applied to the specimen was identified and simultaneously the maximum stress S_{MAX} was obtained, and the stress S₁₂₀₀ at a time point when the strain of 100% was maintained for 1200 seconds was also obtained. The state in which the strain was applied was maintained for 1200 seconds or more from the time point of equipment operation, where the temperature was fixed at −20° C. Here, the ‘1200 seconds’ is the holding time calculated from the time point when the strain begins to be applied.

### 3. Measurement of Recovery Rate

The strain of 100% was maintained for 1200 seconds in the same manner as in the stress-relaxation measurement, and the recovery rate of the pressure-sensitive adhesive was calculated according to the following equation B.

$$Recovery rate ( \% ) = 100 \times ( {S}_{1 s} - {S}_{1200 s} ) / {S}_{1 s} \qquad [ Equation B ]$$

In Equation B, Sis is the stress applied to the pressure-sensitive adhesive at the time point when 1 second has elapsed after applying the shear force in the process of maintaining the strain of 100% for 1200 seconds, and S₁₂₀₀ₛ is the stress applied to the pressure-sensitive adhesive at the time point when 1200 seconds have elapsed after applying the shear force in the process of maintaining the strain of 100% for 1200 seconds.

### 4. Stress Measurement for Sin Strain

The stress on the sin strain of the pressure-sensitive adhesive was evaluated using ARES G2 (Advanced Rheometric Expansion System G2) (TA). A pressure-sensitive adhesive layer sample with a thickness of about 800 μm or so was cut into a circular shape with a diameter of about 8 mm or so to prepare a specimen. The pressure-sensitive adhesive layer sample was prepared by laminating 32 pressure-sensitive adhesive layers with a thickness of about 25 μm or so to have the above thickness. The stress for the Sin strain was evaluated using a parallel plate fixture (diameter: about 8 mm). The device was set so that strains were generated according to the sine wave equation of Equation C below over time in the specimen, and the process that the strain according to Equation C below was applied to the pressure-sensitive adhesive sample for 2 seconds was made as one cycle, whereby the initial stress, maximum stress, and final stress for the specimen were each evaluated, while repeating the cycle 50 times (100 seconds).

$$Sin wave equation = 4 \times sin ( 1.575 \times t ) \qquad [ Equation C ]$$

In Equation C, t is a time (unit: sec).

When the strains are generated in such a manner, the strain of about 400% is generated in the sample within 1 second, and the shear force is applied in the reverse direction so that the strain of 0% is generated within 1 second. Here, the initial stress is the stress identified in the pressure-sensitive adhesive specimen at the time point when each individual cycle begins (i.e., the time point when the shear force is applied), the maximum stress is the largest stress identified in each individual cycle, and the final stress is the stress identified in the pressure-sensitive adhesive specimen at the time point when each individual cycle ends.

### 5. Evaluation of Melting Point and Glass Transition Temperature

A melting point and a glass transition temperature were measured according to a measurement method using a conventional DSC (Differential Scanning Calorimeter) equipment. As the equipment, DSC2500 equipment (TA) was used. About 10 mg of the sample (copolymer) was sealed in a dedicated pan, and the melting point and the glass transition temperature were measured by setting the warming condition to 10° C./min and the cooling condition to −10° C./min, and identifying endothermic and exothermic heat quantities depending on the temperature in an N₂ atmosphere. The measurement temperature range was −120° C. to 200° C. Regarding the conditions, first, it was cooled from room temperature (about 30° C.) to −120° C. at a rate of about −10° C./min, and heated again to 200° C. at a temperature increase rate of 10° C./min (primary heating). Thereafter, it was cooled to −120° C. at a rate of about −10° C./min again, and heated again to 200° C. at a temperature increase rate of 10° C./min (secondary heating). The melting point and the glass transition temperature were evaluated upon the second heating.

### 6. Evaluation of Weight Average Molecular Weight

The weight average molecular weight (Mw) and molecular weight distribution were measured using GPC (Gel Permeation Chromatograph), and the measurement conditions are as follows. When measuring the weight average molecular weight, the measurement results were converted using standard polystyrene (manufactured by Aglient System) to prepare the calibration curve. The molecular weight distribution was a value (Mw/Mn) obtained by obtaining the weight average molecular weight (Mw) and the number average molecular weight (Mn) according to the above method, and then dividing them.

### <GPC Measurement Conditions>

Measuring instrument: Aglient GPC (Aglient 1200 series, U.S.)
Column: connecting two PL Mixed B
Column temperature: 40° C.
Eluent: THE (tetrahydrofuran)
Flow rate: 1.0 μL/min
Concentration: ˜1 mg/mL (100 μl injection)

### 7. Dynamic Folding Test

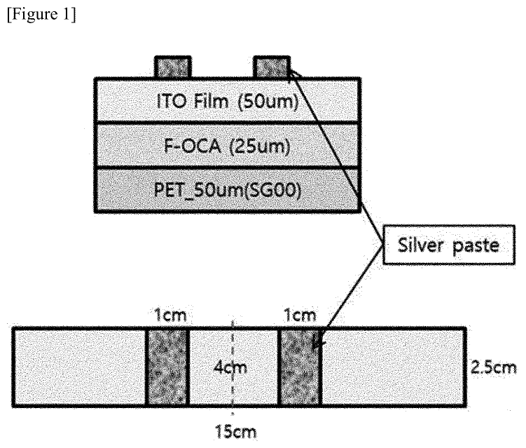

The folding test was performed by preparing a specimen as shown in FIG. 1. An ITO (Indium Tin Oxide) film and a PET (poly(ethylene terephthalate)) film (SG00) were laminated with a pressure-sensitive adhesive (F-OCA) to prepare a sample with a laminated structure of ITO film/pressure-sensitive adhesive layer/PET film, which was cut to have a width of about 15 cm and a length of about 2.5 cm. Here, as the ITO film, one that a crystalline ITO (Indium Tin Oxide) layer with a thickness of about 1 μm or so was formed on the surface of a PET (poly(ethylene terephthalate)) film (base film) with a thickness of about 50 μm or so was used, and as the PET film, a film with a thickness of about 50 μm or so was used, and the thickness of the pressure-sensitive adhesive layer was set to be about 25 μm or so. In addition, the base film of the ITO film was brought into contact with the pressure-sensitive adhesive during lamination. As shown in FIG. 1, a silver paste was printed with a width of about 1 cm on the ITO layer of the cut laminate. Two silver pastes were printed in a state of being about 4 cm or so apart from the left and right based on the center of the ITO layer (dotted line in the lower drawing of FIG. 1). After the printing, the printed pastes were dried at about 150° C. for 1 hour or so. The dynamic folding test was performed using the laminate as a specimen. The specimen was loaded into a dynamic chamber. Then, a process of folding and unfolding the specimen once at the center portion (dotted line portion in the lower drawing of FIG. 1) was set as one cycle, whereby the cycle was repeated. The folding was folded with a curvature of about 2.5R, where the performance temperature was fixed at −20° C., and the process of folding and unfolding once in one cycle was performed for 2 seconds. In addition, the folding proceeded with the silver paste of the ITO film coming to the top. After the folding test, the pressure-sensitive adhesive samples were evaluated according to the following criteria.

### <Evaluation Criteria>

O: when the resistance change rate of the ITO film is 300% or less
Δ: when the resistance change rate of the ITO film is more than 300% and 500% or less
x: when the resistance change rate of the ITO film exceeds 500%

### Preparation Example 1. Preparation of Copolymer (A)

2-Ethylhexyl acrylate (2-EHA), lauryl acrylate (LA) and 4-hydroxybutyl acrylate (HBA) were introduced in a weight ratio of 40:40:20 (2-EHA:LA:HBA) to ethyl acetate as a solvent in a reactor, and about 500 ppm of a radical initiator (2,2′-azobis(4-methoxy-2,4-dimethylvaleronitrile)) was added thereto, and then the mixture was polymerized at about 50° C. for about 8 hours to prepare a polymerization product (copolymer (A)).

### Preparation Example 2. Preparation of Copolymer (B)

2-Ethylhexyl acrylate (2-EHA), lauryl acrylate (LA) and 4-hydroxybutyl acrylate (HBA) were introduced in a weight ratio of 45:40:15 (2-EHA:LA:HBA) to a 50 mL vial, mixed, and nitrogen-purged with N₂. An optical radical initiator (Irgacure 184) was added to the mixture in an amount of about 500 ppm or so, and irradiated with light by a metal halide lamp to prepare a copolymer (B) (irradiation conditions: based on UV A, light quantity: 0.8 J/cm², irradiation time: about 20 seconds). The copolymer (B) was in the form of a partially polymerized prepolymer.

### Preparation Example 3. Preparation of Copolymer (C)

2-Ethylhexyl acrylate (2-EHA) and acrylic acid (AA) were introduced in a weight ratio of 98:2 (2-EHA: AA) to ethyl acetate as a solvent in a reactor, and about 500 ppm of a radical initiator (2,2′-azobis(4-methoxy-2,4-dimethylvaleronitrile)) was added thereto, and then the mixture was polymerized at about 50° C. for about 8 hours to prepare a polymerization product (copolymer (C)).

### Preparation Example 4. Preparation of Copolymer (D)

2-Ethylhexyl acrylate (2-EHA), lauryl acrylate (LA) and 4-hydroxybutyl acrylate (HBA) were introduced in a weight ratio of 60:20:20 (2-EHA:LA:HBA) to ethyl acetate as a solvent in a reactor, and about 500 ppm of a radical initiator (2,2′-azobis(4-methoxy-2,4-dimethylvaleronitrile)) was added thereto, and then the mixture was polymerized at about 50° C. for about 8 hours to prepare a polymerization product (copolymer (D)).

The weight average molecular weights, glass transition temperatures, melting points and molecular weight distributions for the respective copolymers as prepared above were summarized and described in Table 1 below.

TABLE 1

| | | Tg | Tm | Mw | |
|---|---|---|---|---|---|
| | Copolymer | (° C.) | (° C.) | (ten thousand) | PDI |
| Preparation | A | −63 | −44 | 200 | 5.1 |
| Example 1 | | | | | |
| Preparation | B | −63 | −44 | 200 | 2.3 |
| Example 2 | | | | | |
| Preparation | C | −60 | — | 200 | 4.3 |
| Example 3 | | | | | |
| Preparation | D | −61 | — | 200 | 4.8 |
| Example 4 | | | | | |

Tg: glass transition temperature
Tm: melting point
Mw: weight average molecular weight
PDI: molecular weight distribution

### Example 1

A pressure-sensitive adhesive composition was prepared by mixing about 0.07 parts by weight of an isocyanate cross-linking agent (xylylene diisocyanate) and 0.005 parts by weight of a catalyst relative to 100 parts by weight of the copolymer (A) of Preparation Example 1. As the catalyst, a catalyst promoting a urethane reaction between a hydroxyl group and an isocyanate group was generally used. The prepared pressure-sensitive adhesive composition was applied on the release surface of a release PET (poly(ethylene terephthalate)) film, and maintained at 130° C. for about 3 minutes or so to form a pressure-sensitive adhesive layer with a thickness of about 25 μm or so.

### Example 2

A pressure-sensitive adhesive composition was prepared by mixing the copolymer (prepolymer) (B) of Preparation Example 2 with about 0.05 parts by weight of 1,6-hexanediol diacrylate and about 3 parts by weight of an initiator (Irgacure 651) relative to 100 parts by weight of the copolymer (B). The pressure-sensitive adhesive composition was applied on the release surface of a release PET (poly(ethylene terephthalate)) film, and irradiated with ultraviolet rays to form a pressure-sensitive adhesive layer with a thickness of about 25 μm or so (ultraviolet irradiation conditions: wavelength=about 365 nm (black light lamp), total light quantity=about 1 J/cm², irradiation time: about 3 minutes).

### Comparative Example 1

A pressure-sensitive adhesive composition was prepared by mixing about 0.035 parts by weight of a cross-linking agent (manufacturer: Samyoung Ink Paint Co., product name: 0.03 parts by weight of BXX-5240 and 0.005 parts by weight of BXX-5627) relative to 100 parts by weight of the copolymer (polymerization product) (C) of Preparation Example 3. The prepared pressure-sensitive adhesive composition was applied on the release surface of a release PET (poly(ethylene terephthalate)) film, and maintained at 130° C. for about 3 minutes or so to form a pressure-sensitive adhesive layer with a thickness of about 25 μm or so.

### Comparative Example 2

A pressure-sensitive adhesive composition was prepared by mixing about 0.07 parts by weight of an isocyanate cross-linking agent (xylylene diisocyanate) and 0.005 parts by weight of a catalyst relative to 100 parts by weight of the copolymer (D) of Preparation Example 4. As the catalyst, a catalyst promoting a urethane reaction between a hydroxyl group and an isocyanate group was generally used. The prepared pressure-sensitive adhesive composition was applied on the release surface of a release PET (poly(ethylene terephthalate)) film, and maintained at 130° C. for about 3 minutes or so to form a pressure-sensitive adhesive layer with a thickness of about 25 μm or so.

### Comparative Example 3

As Comparative Example 3, 3M's OCA pressure-sensitive adhesive (trade name: CEF3502) was used. The pressure-sensitive adhesive was formed to a thickness of about 25 μm on the release surface of a release PET (poly(ethylene terephthalate)) film to obtain Comparative Example 3.

The results of evaluating the elastic modulus of the pressure-sensitive adhesive layers of Examples and Comparative Examples were summarized in Table 2 below. In Table 2 below, the elastic modulus (Young's Modulus) (unit: Pa) is a value obtained through Equation A above, STS_{MAX} is the maximum stress (unit: Pa) applied to the pressure-sensitive adhesive within the linear section described in the measurement method, and STS_{MIN} is the minimum stress (unit: Pa) applied to the pressure-sensitive adhesive within the linear section, STN_{MAX} is the strain (unit: %) where the maximum stress is identified, and STN_{MIN} is the strain (unit: %) where the minimum stress is identified. The results in Table 2 below are the results measured at about −20° C.

TABLE 2

| | Example | | Comparative Example | | |
|---|---|---|---|---|---|
| | 1 | 2 | 1 | 2 | 3 |
| STS_{MAX} | 8962 | 24013 | 49440 | 34649 | 34354 |
| (Pa) | | | | | |
| STS_{MIN} | 2840 | 8013 | 16560 | 11879 | 11607 |
| (Pa) | | | | | |
| STN_{MAX} | 3.94 | 3.94 | 3.94 | 3.94 | 3.94 |
| (%) | | | | | |
| STN_{MIN} | 0.78 | 0.78 | 0.78 | 0.78 | 0.78 |
| (%) | | | | | |
| Elastic | 193734 | 506329 | 1040506 | 720570 | 719842 |
| modulus | | | | | |
| (Pa) | | | | | |
| Folding | ∘ | ∘ | x | Δ | Δ |
| test | | | | | |

The results of evaluating Stress-Relaxation for the pressure-sensitive adhesive layers of Examples and Comparative Examples were summarized in Table 3 below. In Table 3 below, MAX Stress is the maximum stress (S_{MAX}) identified in the Stress-Relaxation evaluation process, and 1200s Stress is the stress (S₁₂₀₀) applied to the pressure-sensitive adhesive at the time point when 1200 seconds have elapsed from the time point of equipment operation in the Stress-Relaxation measurement, which is S₁₂₀₀ₛ of Equation B for the recovery rate evaluation, and is Stress is the stress applied to the pressure-sensitive adhesive at the time point when 1 second has elapsed from the time point of equipment operation, which is Sls of Equation B for the recovery rate evaluation.

TABLE 3

| | Example | | Comparative Example | | |
|---|---|---|---|---|---|
| | 1 | 2 | 1 | 2 | 3 |
| MAX Stress | 361516 | 353847 | 741978 | 675948 | 473204 |
| (Pa) | | | | | |
| 1200 s Stress | 8443 | 7251 | 16104 | 13503 | 18770 |
| (Pa) | | | | | |
| 1 s Stress | 42411 | 42732 | 66765 | 63251 | 72708 |
| (Pa) | | | | | |
| Recovery | 80.1 | 83 | 75.9 | 78.7 | 74.2 |
| rate (%) | | | | | |
| Folding | ∘ | ∘ | x | Δ | Δ |
| test | | | | | |

The stress measurement results for Sin strain with regard to the pressure-sensitive adhesive layers of Examples and Comparative Examples were summarized in Table 4 below. In Table 4 below, 1 Cycle, 10 Cycle and 50 Cycle mean the results at the 1st cycle, 10th cycle and 50th cycle, respectively. In addition, Initial is the stress at the start time point of each cycle, MAX is the maximum stress measured in each cycle, and LAST means the stress at the end time point of each cycle.

Therefore, in Table 4 below, MAX at 1 Cycle is S_{MAX1} in Equations 1, 3 and 5, MAX at 10 Cycle is S_{MAX10} in Equations 3, 4 and 7, and MAX at 50 Cycle is S_{MAX50} in Equations 1, 4 and 6. In Table 4 below, LAST at 1 Cycle is S_{LAST1} in Equation 5, LAST at 10 Cycle is S_{LAST10} in Equation 7, and LAST at 50 Cycle is S_{LAST50} in Equation 6.

TABLE 4

| | | Example | | Comparative Example | | |
|---|---|---|---|---|---|---|
| | | 1 | 2 | 1 | 2 | 3 |
| 1 | Initial (Pa) | 0 | 0 | 0 | 0 | 0 |
| Cycle | MAX (Pa) | 295603 | 296432 | 514643 | 485417 | 387628 |
| | LAST (Pa) | −140432 | −145564 | −275850 | −248016 | −175614 |
| 10 | Initial (Pa) | −25744 | −30981 | −36572 | −30936 | −42271 |
| Cycle | MAX (Pa) | 205268 | 203996 | 334632 | 323430 | 278735 |
| | LAST (Pa) | −163192 | −172641 | −291753 | −274112 | −208117 |
| 50 | Initial (Pa) | −37221 | −42783 | −49996 | −49031 | −58760 |
| Cycle | MAX (Pa) | 181817 | 181923 | 304398 | 284982 | 250300 |
| | LAST (Pa) | −174448 | −185235 | −307775 | −288983 | −223901 |

| | | | | | |
|---|---|---|---|---|---|
| Folding test | ∘ | ∘ | x | Δ | Δ |

The results of the dynamic folding test performed on the pressure-sensitive adhesive layers of Examples and Comparative Examples were summarized in Table 5 below. In Table 5 below, 50,000 Cycle and 100,000 Cycle represent the results of performing the cycle of folding and then unfolding with a curvature of about 2.5R described in the measurement method 50,000 times and 100,000 times, respectively. In addition, the numerical value described in Table 5 below means the ratio of the increase in the resistance value when the resistance value of the initial ITO film is 100% (that is, for example, when the numerical value is 400%, it means that the resistance value increases 4 times).

TABLE 5

| | |
|---|---|
| Example | Comparative Example |

| | 1 | 2 | 1 | 2 | 3 |
|---|---|---|---|---|---|
| 50,000 Cycle | 200% | 250% | 650% | 310% | 500% |
| 100,000 Cycle | 220% | 300% | 1100% | 400% | 1000% |
| Folding test | ∘ | ∘ | x | Δ | Δ |

1. A pressure-sensitive adhesive having a maximum stress S_{MAX} of 1 MPa or less as measured while maintaining a strain of 100% applied to the pressure-sensitive adhesive for 1200 seconds, the strain of 100% obtained within 0.05 seconds by a shear force applied at −20° C., and having a stress S₁₂₀₀ of 12,000 Pa or less at a time point when the strain of 100% is maintained for 1200 seconds.

2. A pressure-sensitive adhesive, wherein ΔS_{X1} of Equation 1 below is 3,500 Pa/time or less, and S_{MAX50} of Equation 1 below is 250,000 Pa or less:
$$Δ {S}_{X 1} = 0.02 \times ( {S}_{MAX 1} - {S}_{MAX 50} ) \qquad [ Equation 1 ]$$
wherein, S_{MAX1} is a maximum stress (unit: Pa) identified within a time period of 0 seconds to 2 seconds in a process of applying a shear force to the pressure-sensitive adhesive for 100 seconds according to Equation 2 below at −20° C., and S_{MAX50} is a maximum stress (unit: Pa) identified within a time period of 99 seconds to 100 seconds in the process of applying the shear force to the pressure-sensitive adhesive for 100 seconds according to Equation 2 below at −20° C.:
$$Sin wave equation = 4 \times sin ( 1.575 \times t ) \qquad [ Equation 2 ]$$
wherein, t is a time (unit: sec).

3. The pressure-sensitive adhesive according to claim 1, wherein a ratio (S_{MAX}/S₁₂₀₀) of the maximum stress S_{MAX} relative to the stress S₁₂₀₀ is in a range from 30 to 60.

4. The pressure-sensitive adhesive according to claim 1, wherein ΔS_{X2} of Equation 3 below is 15,000 Pa/time or less:
$$Δ {S}_{X 2} = 0.1 \times ( {S}_{MAX 1} - {S}_{MAX 10} ) \qquad [ Equation 3 ]$$
wherein, S_{MAX1} is a maximum stress (unit: Pa) identified within a time period of 0 seconds to 2 seconds in a process of applying a shear force to the pressure-sensitive adhesive for 100 seconds according to Equation 2 below at −20° C., and S_{MAX10} is a maximum stress (unit: Pa) identified within a time period of 19 seconds to 20 seconds in the process of applying the shear force to the pressure-sensitive adhesive for 100 seconds according to Equation 2 below at −20° C.:
$$Sin wave equation = 4 \times sin ( 1.575 \times t ) \qquad [ Equation 2 ]$$
wherein, t is a time (unit: sec).

5. The pressure-sensitive adhesive according to claim 1, wherein ΔS_{X3} of Equation 4 below is 700 Pa/time or less:
$$Δ {S}_{X 3} = 0.025 \times ( {S}_{MAX 10} - {S}_{MAX 50} ) \qquad [ Equation 4 ]$$
wherein, S_{MAX10} is a maximum stress (unit: Pa) identified within a time period of 19 seconds to 20 seconds in a process of applying a shear force to the pressure-sensitive adhesive for 100 seconds according to Equation 2 below at −20° C., and S_{MAX50} is a maximum stress (unit: Pa) identified within a time period of 99 seconds to 100 seconds in the process of applying the shear force to the pressure-sensitive adhesive for 100 seconds according to Equation 2 below at −20° C.:
$$Sin wave equation = 4 \times sin ( 1.575 \times t ) \qquad [ Equation 2 ]$$
wherein, t is a time (unit: sec).

6. The pressure-sensitive adhesive according to claim 1, wherein ΔS_{XL1} of Equation 5 below is 600,000 Pa or less:
$$Δ {S}_{XL 1} = ( {S}_{MAX 1} - {S}_{LAST 1} ) \qquad [ Equation 5 ]$$
wherein, S_{MAX1} is a maximum stress (unit: Pa) identified within a time period of 0 seconds to 2 seconds in a process of applying a shear force to the pressure-sensitive adhesive for 100 seconds according to Equation 2 below at −20° C., and S_{LAST1} is a stress (unit: Pa) identified at 2 seconds during the process of applying the shear force to the pressure-sensitive adhesive for 100 seconds according to Equation 2 below at −20° C.:
$$Sin wave equation = 4 \times sin ( 1.575 \times t ) \qquad [ Equation 2 ]$$
wherein, t is a time (unit: sec).

7. The pressure-sensitive adhesive according to claim 1, wherein ΔS_{XL50} of Equation 6 below is 500,000 Pa or less:
$$Δ {S}_{XL 50} = ( {S}_{MAX 50} - {S}_{LAST 50} ) \qquad [ Equation 6 ]$$
wherein, S_{MAX50} is a maximum stress (unit: Pa) identified within a time period of 99 seconds to 100 seconds in a process of applying a shear force to the pressure-sensitive adhesive for 100 seconds according to Equation 2 below at −20° C., and S_{LAST50} is a stress (unit: Pa) identified at 100 seconds during the process of applying the shear force to the pressure-sensitive adhesive for 100 seconds according to Equation 2 below at −20° C.:
$$Sin wave equation = 4 \times sin ( 1.575 \times t ) \qquad [ Equation 2 ]$$
wherein, t is a time (unit: sec).

8. The pressure-sensitive adhesive according to claim 1, wherein ΔS_{XL10} of Equation 7 below is 500,000 Pa or less:
$$Δ {S}_{XL 10} = ( {S}_{MAX 10} - {S}_{LAST 10} ) \qquad [ Equation 7 ]$$
wherein, S_{MAX10} is a maximum stress (unit: Pa) identified within a time period of 19 seconds to 20 seconds in a process of applying a shear force to the pressure-sensitive adhesive for 100 seconds according to Equation 2 below at −20° C., and S_{LAST10} is a stress (unit: Pa) identified at 20 seconds during the process of applying the shear force to the pressure-sensitive adhesive for 100 seconds according to Equation 2 below at −20° C.:
$$Sin wave equation = 4 \times sin ( 1.575 \times t ) \qquad [ Equation 2 ]$$
wherein, t is a time (unit: sec).

9. The pressure-sensitive adhesive according to claim 1, wherein a recovery rate is at least 70%.

10. The pressure-sensitive adhesive according to claim 1, wherein an elastic modulus at −20° C. is 1 MPa or less, and a maximum stress in a linear section of a strain-stress curve for identifying the elastic modulus is 30,000 Pa or less.

11. The pressure-sensitive adhesive according to claim 1, comprising a pressure-sensitive adhesive polymer.

12. The pressure-sensitive adhesive according to claim 11, wherein the pressure-sensitive adhesive polymer is an acrylic copolymer having a glass transition temperature (Tg) and a melting temperature (Tm).

13. The pressure-sensitive adhesive according to claim 12, wherein the acrylic copolymer has the glass transition temperature of −30° C. or less and the melting temperature of −10° C. or less.

14. The pressure-sensitive adhesive according to claim 12, wherein a difference (Tm−Tg) between the melting temperature and the glass transition temperature is at least 5° C.

15. The pressure-sensitive adhesive according to claim 12, wherein the acrylic copolymer has a molecular weight distribution of more than 3, and the acrylic copolymer is cross-linked with a thermal cross-linking agent.

16. The pressure-sensitive adhesive according to claim 12, wherein the acrylic copolymer has a molecular weight distribution of 3 or less, and the acrylic copolymer is cross-linked with a radical cross-linking agent.

17. The pressure-sensitive adhesive according to claim 12, wherein the acrylic copolymer comprises an alkyl (meth)acrylate unit, a unit of Formula 1 below, and a polar functional group-containing unit: 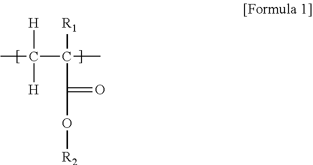
wherein, R₁ represents hydrogen or an alkyl group, and R₂ represents an alkyl group with 11 to 13 carbon atoms.

18. A pressure-sensitive adhesive film comprising a base film; and the pressure-sensitive adhesive of claim 1 formed on one side or both sides of the base film.

19. A flexible device comprising:
a display panel configured to be capable of folding or rolling through one or more folding axes or rolling axes; and
the pressure-sensitive adhesive of claim 1 formed on one side or both sides of the display panel.
